(19) United States
(12) Patent Application Publication
(10) Pub. No.: US 2011/0196104 A1
(43) Pub. Date: Aug. 11, 2011

(54) Norbornene-based copolymers with iridium complexes and exiton transport groups in their side-chains and use thereof

(75) Inventors: Alpay Kimyonok, Istanbul (TR); Benoit Domercq, Waterloo (BE); Andreas Haldi, Dresden (DE); Jian-Yang Cho, Ambler, PA (US); Joseph R. Carlise, Annandale, NJ (US); Xian-Yong Wang, Duluth, GA (US); Lauren E. Hayden, Atlanta, GA (US); Simon C. Jones, Los Angeles, CA (US); Stephen Barlow, Atlanta, GA (US); Seth R. Marder, Atlanta, GA (US); Bernard Kippelen, Decatur, GA (US); Marcus Weck, New York, NY (US)

(73) Assignee: GEORGIA TECH RESEARCH CORPORATION, Atlanta, GA (US)

(21) Appl. No.: 12/673,299

(22) PCT Filed: Aug. 18, 2008
(86) PCT No.: PCT/US08/73491

§ 371 Date: Feb. 25, 2011

Related U.S. Application Data
(60) Provisional application No. 60/956,492, filed on Aug. 17, 2007.
(60) Provisional application No. 61/040,212, filed on Mar. 28, 2008.

(51) Int. Cl. C08F 275/00; C08F 130/04

(52) U.S. Cl. 525/274; 526/241

(57) ABSTRACT

The present invention describes compounds with iridium complexes and poly(norbornene)s made therefrom. Methods of making the compounds and the poly(norbornene)s are also described. Further disclosed herein are light-emitting diodes employing such poly(norbornene)s which are covalently attached to a hole transport material.

This application is being filed on Aug. 18, 2008, as a PCT International Patent application in the name of Georgia Tech Research Corporation, a U.S. national corporation, applicant for the designation of all countries except the US, and Alpay Kimyonok a citizen of Turkey, Benoit Domercq a citizen of France, Andreas Haldi a citizen of Switzerland, Jian-Yang Cho a citizen of Taiwan, Joseph R. Carlise a citizen of the U.S., Xian-Yong Wang a citizen of China, Lauren E. Hayden a citizen of the U.S., Simon C. Jones and Stephen Barlow both citizens of the United Kingdom, Seth R. Marder a citizen of the U.S., Bernard Kippelen a citizen of France, and Marcus Weck a citizen of Germany, applicants for the designation of the US only, and claims priority to U.S. Provisional patent application Ser. Nos. 60/956,492, filed Aug. 17, 2007, and 61/040,212, FILED Mar. 28, 2008.

### STATEMENT OF GOVERNMENT LICENSE RIGHTS

The inventors received partial funding support through the STC Program of the National Science Foundation under Agreement Number DMR-020967 and the Office of Naval Research through a MURI program, Contract Award Number 68A-1060806. The Federal Government may retain certain license rights in this invention.

### TECHNICAL FIELD OF THE INVENTION

These inventions relate to the field of electro-optical materials, including organic light-emitting diodes (OLEDs) and the emission and electron-transport layer of OLEDs.

### BACKGROUND OF THE INVENTION

Phosphorescent metal complexes have been investigated for use in organic light-emitting diodes (OLEDs). Such OLED's can contain a light emissive layer disposed between a layer comprising a hole transport material (on the anode side of the OLED) and a layer comprising an electron transport material (on the cathode side of the OLED). The present inventions relate to certain norbornene copolymers having phosphorescent Iridium complexes bonded thereto, for use in the emissive layer of such OLEDs. Upon application of a voltage/current across the OLED, holes and electrons are conducted into the emissive layer, wherein they stimulate the formation of excited states of the Iridium metal complexes, which then emit phosphorescent light.

In the relevant metal complexes, singlet excited states are often initially formed, but then spin-orbit coupling can induce intersystem crossing from the singlet to the phosphorescent triplet excited state. Although not being bound by theory, using phosphorescent materials as emission centers for OLEDs allows for the collection of all the singlet and triplet excitons generated upon electrical excitation in an OLED device. It has been reported that OLEDs based on phosphorescent transition metal complexes have nearly 100% internal quantum efficiencies. In particular, third-row transition metal complexes are used widely in OLEDs as a result of the heavy-atom effect on the spin-orbit coupling.

Certain iridium complexes with emission spectra that span the entire visible spectrum have been synthesized and employed in vacuum-deposited OLEDs with high external quantum efficiencies. For example, external quantum efficiencies as high as 19% have been obtained for a system utilizing a 2-phenylpyridinato-based iridium complex doped into a wide energy gap host. See, for example, Friend, R. H.; Gymer, R. W.; Holmes, A. B.; Burroughes, J. H.; Marks, R. N.; Taliani, C.; Bradley, D. D. C.; Dos Santos, D. A.; Brédas, J. L.; Lögdlund, M.; Salaneck, W. R. Nature 1999, 397, 121, Thompson, M., E.; Burrows, P. E.; Forrest, S. R. Curr. Opin. Solid State Mater. Sci. 1999, 4, 369, Köhler, A., Wilson, J. S.; Friend, R. H. Adv. Mater. 2002, 14, 701, Yersin, H. Top. Curr. Chem. 2004, 241, 1, Holder, E.; Langeveld, B. M. W.; Schubert, U.S. Adv. Mater. 2005, 17, 1109, Lowry, M. S.; Bernhard, S. Chem. Eur. J. 2006, 12, 7970, Adachi, C.; Baldo, M. A.; Forrest, S. R.; Thompson, M. E. Appl. Phys. Lett. 2000, 77, 904, Adachi, C.; Baldo, M. A.; Thompson, M. E.; Forrest, S. R. J. Appl. Phys. 2001, 90, 5048, Lamansky, S.; Djurovich, P.; Murphy, D.; Abdel-Razzaq, F.; Lee, H.-E.; Adachi, C.; Burrows, P. E.; Forrest, S. R.; Thompson, M. E. J. Am. Chem. Soc. 2001, 123, 4304, Lamansky, S.; Djurovich, P.; Murphy, D.; Abdel-Razzaq, F.; Kwong, R.; Tsyba, I.; Bortz, M.; Mui, B.; Bau, R.; Thompson, M. E. Inorg. Chem. 2001, 40, 1704, Adachi, C.; Baldo, M. A.; Forrest, S. R.; Lamansky, S.; Thompson, M. E, Kwong, R. C. Appl. Phys. Lett. 2001, 78, 1622, Tsuboyama, A.; Iwawaki, H.; Furugori, M.; Mukaide, T.; Kamatani, J.; Igawa, S.; Moriyama T.; Miura, S.; Takiguchi, T.; Okada, S.; Hoshino, M.; Ueno, K. J. Am. Chem. Soc. 2003, 125, 12971, Nazeeruddin, M. K.; Humphry-Baker, R.; Berner, D.; Rivier, S.; Zuppiroli, L.; Grätzel, M. J. Am. Chem. Soc. 2003, 125, 8790, and Tamayo, A. B.; Alleyne, B. D.; Djurovich, P. I.; Lamansky, S.; Tsyba, I.; Ho, N. N.; Bau, R.; Thompson, M. E. J. Am. Chem. Soc. 2003, 125, 7377, each of which respectively is incorporated herein by reference in its entirety.

Such vacuum deposited iridium complexes, as well as solution processable approaches for incorporation of iridium complexes into OLEDs have been explored. For example, covalent anchoring of small molecule components to polymer backbones, resulting in materials that can be solution-processed and, if desired, photo-patterned has been reported. Both conjugated and non-conjugated polymer backbones have been employed in this strategy to produce solution processable iridium containing materials. See also, for example, Chen, X.; Liao, J.-L.; Liang, Y.; Ahmed, M. O.; Tseng, H.-E.; Chen, S.-A. J. Am. Chem. Soc. 2003, 125, 636, Sandee, A. J.; Williams, C. K.; Evans, N. R.; Davies, J. E.; Boothby, C. E.; Köhler, A.; Friend, R. H.; Holmes, A. B. J. Am. Chem. Soc. 2004, 126, 7041, Jiang, J.; Jiang, C.; Yang, W.; Zhen, H.; Huang, F.; Cao, Y. Macromolecules 2005, 38, 4072, You, Y.; Kim, S. H.; Jung, H. K.; Park, S. Y. Macromolecules 2006, 39, 349, Zhen, H., Luo, C.; Yang, W.; Song, W.; Du, B.; Jiang, J.; Jiang, C.; Zhang, Y.; Cao, Y. Macromolecules 2006, 39, 1693, Deng, L.; Furuta, P. T.; Garon, S.; Li, J.; Kavulak, D.; Thompson, M. E.; Fréchet, J. M. J. Chem. Mater. 2006, 18, 386, Evans, N. R.; Devi, L. S.; Mak, C. S. K.; Watkins, S. E.; Pascu, S. I.; Köhler, A.; Friend, R. H.; Williams, C. K.; Holmes, A. B. J. Am. Chem. Soc. 2006, 128, 6647, Schulz, G. L.; Chen, X.; Chen, S.-A.; Holdcroft S. Macromolecules 2006, 39, 9157, Zhang, K.; Chen, Z.; Yang, C.; Gong, S.; Qin, J.; Cao, Y. Macromol. Rapid Commun. 2006, 27, 1926, Jiang, J.; Xu, Y.; Yang, W.; Guan, R.; Liu, Z.; Zhen, H.; Cao, Y. Adv. Mater. 2006, 18, 1769, Carlise, J. R.; Wang, X.-Y.; Weck, M. Macromolecules 2005, 38, 9000, Wang, X.-Y.; Prabhu, R. N.; Schmehl, R. H.; Weck, M. Macromolecules 2006, 39, 3140, Wang, X.-Y.; Kimyonok, A.; Weck, M. Chem. Commun. 2006, 3933, Kimyonok A, Weck, M. Macromol. Rapid Commun. 2007, 28, 152, Kimyonok, A.; Wang, X-Y.; Weck, M. Polym. Rev. 2006, 46, 47, Meyers, A.; Weck, M. Macromolecules 2003, 36, 1766, Meyers, A.; South, C.; Weck, M. Chem. Commun. 2004, 1176, Meyers, A.; Weck, M. Chem. Mater. 2004, 16, 1183, Wang, X-Y.; M. Weck, Macromolecules 2005, 38, 7219, Meyers, A.; Kimyonok, A.; M. Weck, Macromolecules 2005, 38, 8671, Bellmann, E.; Shaheen, S. E.; Thayumanavan, S.; Barlow, S.; Marder, S. R.; Kippelen, B.; Peyghambarian, N. Chem. Mater. 1998, 10, 1668, Bellmann, E.; Shaheen, S. E.; Grubbs, R. H.; Marder, S. R.; Kippelen, B.; Peyghambarian, N. Chem. Mater. 1999, 11, 399, Zhang, Y.-D.; Hreha, R. D.; Marder, S. R.; Jabbour, G. E.; Kippelen, B.; Peyghambarian, N. J. Mater. Chem. 2002, 12, 1703, Feast, W. J.; Peace, R. J.; Sage, I. C.; Wood, E. L. Polym. Bull. 1999, 42, 167, Jiang, X. Z.; Liu, S.; Liu, M. S.; Herguth, P.; Jen, A. K.-Y.; Sarikaya, M. Adv. Funct. Mater. 2002, 12, 745, Mutaguchi, D.; Okumoto, K.; Ohsedo, Y.; Moriwaki, K.; Shirota, Y. Org. Electron. 2003, 4, 49, Bacher, E.; Bayerl, M.; Rudati, P.; Reckefuss, N.; Müller, C. D.; Meerholz, K.; Nuyken, O. Macromolecules 2005, 38, 1640, Niu, Y.-H.; Liu, M. S.; Ka, J.-W.; Jen, A. K.-Y. Appl. Phys. Lett. 2006, 88, 093505, Deng, L.; Furuta, P. T.; Garon, S.; Li, J.; Kavulak, D.; Thompson, M. E.; Fréchet, J. M. J. Chem. Mater. 2006, 18, 386, Markham, J. P. J.; Lo, S. C.; Magennis, S. W.; Bum, P. L.; Samuel, I. D. W., Appl. Phys. Lett. 2002, 80, 2645, Furuta, P.; Brooks, J.; Thompson, M. E.; Fréchet, J. M. J. J. Am, Chem. Soc. 2003, 125, 13165, Bronk, K.; Thayumanavan, S. J. Org. Chem. 2003, 68, 5559, Son, H.-J.; Han, W.-S.; Lee, K. H.; Jung, H. J.; Lee, C.; Ko, J.; Kang, S. O. Chem. Mater. 2006, 18, 5811, Domercq, B.; Hreha, R. D.; Zhang, Y.-D.; Haldi, A.; Barlow, S.; Marder, S. R.; Kippelen, B., J. Polym. Sci. Part B: Polym. Phys. 2003, 41, 2726, Domercq, B.; Hreha, R. D.; Zhang, Y.-D.; Larribeau, N.; Haddock, J. N.; Schultz, C.; Marder, S. R.; Kippelen, B. Chem. Mater. 2003, 15, 1491, each of which respectively is incorporated herein by reference in its entirety.

However, devices based on polymeric materials often have lower performances than equivalent devices based on vacuum-deposited material. What are needed are new polymeric compounds, materials, compositions, and methods that can address these and other deficiencies in the art. It is to that end the present invention is directed.

### SUMMARY OF THE INVENTION

The present inventions are related to metal complexes, especially copolymerizable or copolymerized Iridium complexes of bidentate ligands having the structure:

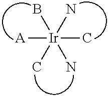

wherein the

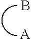

bidentate ligand that is linked to a monomeric co-polymerizable norbornene group, and/or the resulting copolymerized polynorbornenes, wherein the copolymers comprising the metal complexes linked thereto are useful for making organic light-emitting diodes.

Specific examples of the

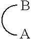

bidentate ligands linked to a co-polymerizable norbornene group include the 2-phenyl-pyridine compounds linked to polymerizable norbornenes as shown below, which can be reacted with Iridium complexes comprising two other:

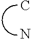

bidentate ligands to form a Iridium complex linked to a copolymerizable norbornene group, as indicated below.

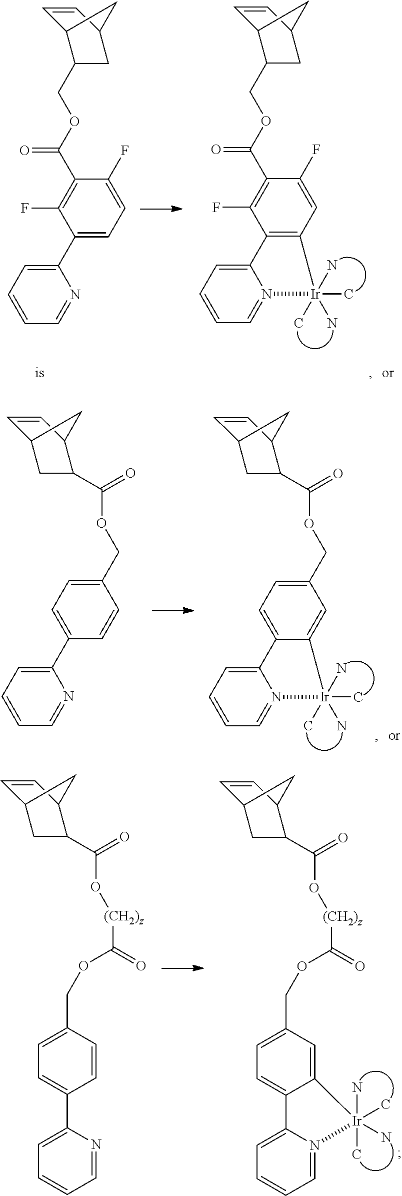

wherein z is an integer from 1 to 20, or 1 to 10.

The norbornene monomers comprising the emissive Iridium complexes described above can be co-polymerized via ring-opening metathesis polymerization (ROMP) with other norbornene co-monomers that comprise poly-unsaturated and polycyclic heteroaromatic “host” group side chains “Rₕ” that are capable of conducting holes and, electrons, so that the holes and electrons, or exitons are transported into contact with the Iridium complexes so as to cause the formation of excited states of the Iridium complexes.

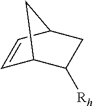

The structure of the norbornene co-monomers that comprise “Rₕ” “host” group side chains typically contain poly-unsaturated and polycyclic heteroaromatic groups that are chosen so that the energies of energies of the singlet and triplet states of the host material or molecule are chosen to be larger than those of the singlet and phosphorescent excited states of the phosphorescent metal complex.

Examples of such co-monomers comprising poly-unsaturated and polycyclic heteroaromatic “host” groups “Rₕ” include those shown below, or optionally substituted variations thereof, as further disclosed hereinbelow:

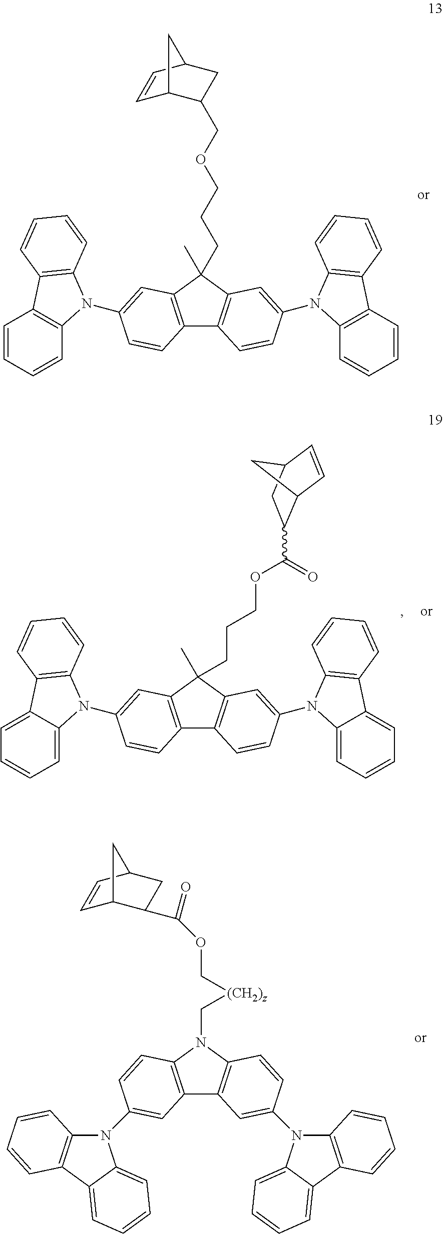

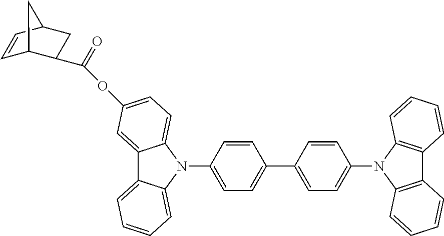

The resulting novel copolymers (which can be either random or block copolymers) can have the structure:

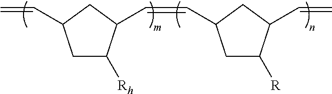

wherein Rₕ is the group comprising the poly-unsaturated and polycyclic heteroaromatic “host” groups, and R is the group comprising the phosphorescent Iridium complex, and n is an integer from 5 to 30; and the ratio m:n can be from 70:30 to 95:5, can preferably be from 60:40 to 90:10.

In such copolymeric “host materials,” the Iridium complexes and host groups are well dispersed within and permanently bonded to polymer backbone. The Rₕ host groups can conduct holes and electrons to the dispersed metal complexes (via known mechanisms such as Förster energy transfer or Dexter energy transfer) so as to efficiently form phosphorescent excited states in the Iridium metal complexes.

An example of such copolymers includes the structure shown below

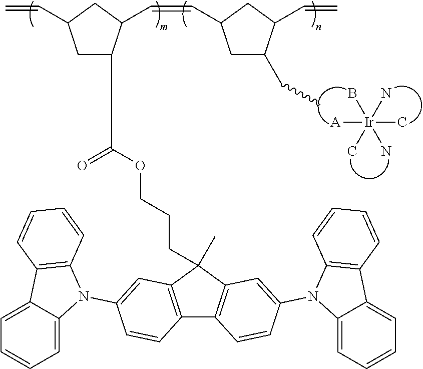

Such copolymers can conduct both holes and electrons, and thereby form excited states of the Iridium complexes, which emit in various regions of the visible spectrum, depending upon the detailed characteristics of the Iridium complex attached thereto. Such copolymers can be solution processed and spin coated onto appropriate substrates, in the presence of crosslinking agents comprising cinnamate groups, and photo-patterned to crosslink the copolymer, as part of the process of making the desired OLEDs.

The physical and emissive properties of the Iridium complexes can be rationally manipulated by variations in the structure and/or substituents of the ligands of the Iridium complexes.

The two

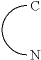

ligands of the monomeric or co-polymeric Iridium complexes can have variable structures that can contain a variety of optional peripheral substituents that can be varied so as to “tune” the physical and phosphorescent properties of the Iridium complexes.

The structure of the two bidentate

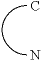

ligands for the Iridium complexes, (for either the monomeric form or the co-polymeric form of the Ir complexes) include the 2-phenyl-pyridine ligands and close analog ligands, as shown below,:

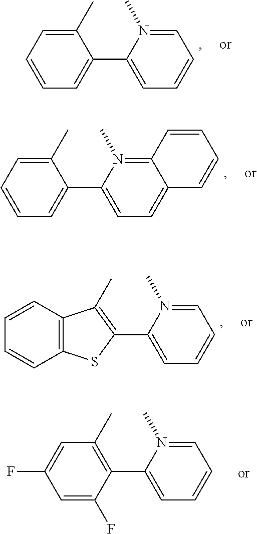

Moreover, the two

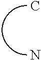

ligands for the Iridium complex can be optionally substituted with a variety of inorganic or organic substituent groups, as illustrated for example below;

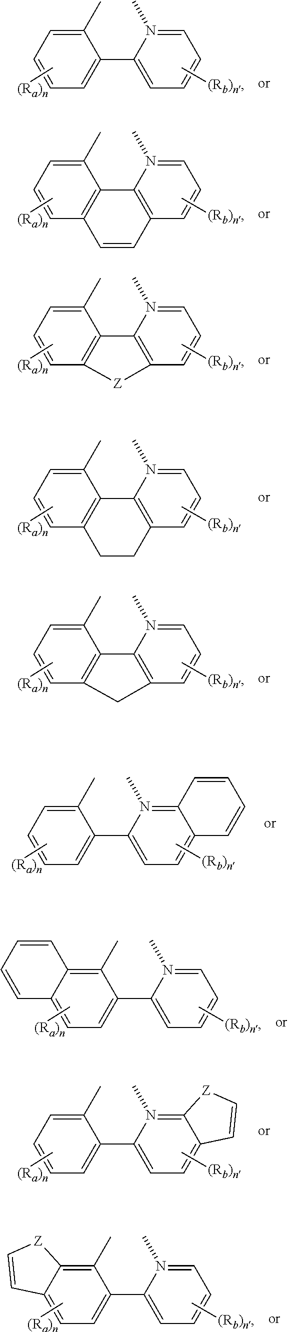

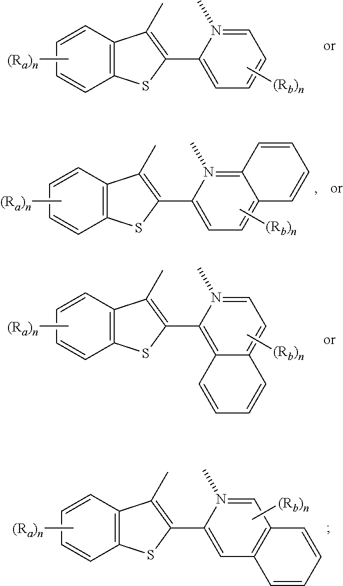

wherein Z is O or S,
and wherein n and n′ are integer indexes that can be the same or different and can have the values 0, 1, 2, or 3, with the proviso that at least one of n or n′ is not zero, and z is an integer from 1 to 20, or 1 to 10.

In such substituted bidentate ligands, the Rₐ and R_{b} group can be the same or different, and the ligand substituent groups Rₐ and R_{b} can be varied so as to “tune” the emission wavelengths of the resulting Iridium complexes, as will be further disclosed below.

In another aspect of the present inventions provide novel co-poly(norbornene)s having the following structure:

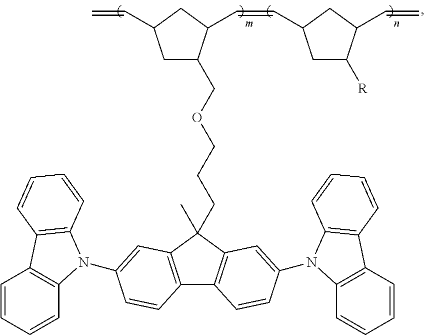

wherein:
n is an integer from 5 to 30; and m:n can be from 70:30 to 95:5,

### R is

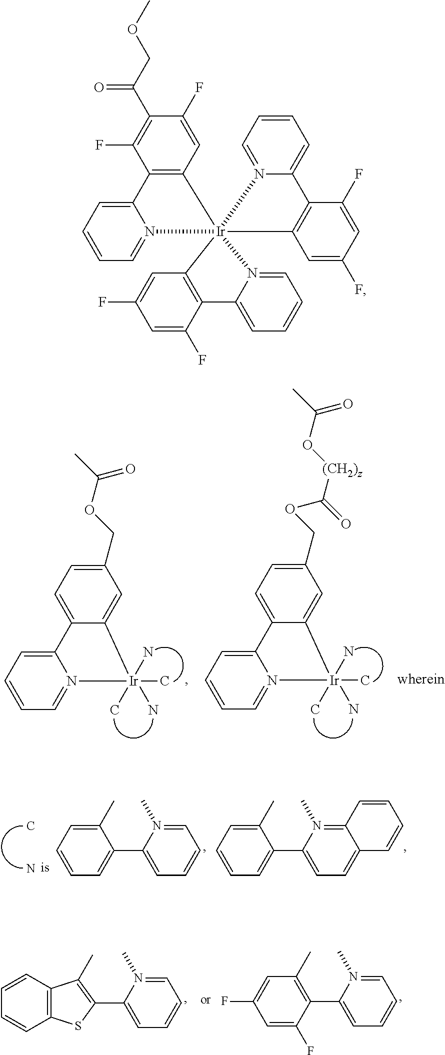

or various substituted derivatives thereof, wherein the

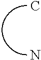

ligand is the same in each instance for the respective compound, and z is an integer from 1 to 20, or 1 to 10.

Still, in another aspect of the present invention, light emitting diodes are described which comprise the above poly(norbornene)s.

In another aspect of the present invention, light emitting diodes are described which comprise a hole transport material, and the above poly(norbornene)s.

### BRIEF DESCRIPTION OF THE FIGURES

FIG. 1 illustrates Mₙ as a function of monomer-to-catalyst ratio for the homopolymerization of compound 13.

FIG. 2 illustrates the solid-state photoluminescence emission spectra of copolymers 14-17.

FIG. 3 illustrates the electroluminescence spectra for devices with structure ITO/18/(14-17)/BCP/AlQ₃/LiF/Al (35 nm/25 nm/6 nm/20 nm/1 nm/150 nm).

FIG. 4 illustrates current density, luminance, and external quantum efficiency as a function of applied voltage for device with structure ITO/18/(16 or 17)/BCP/AlQ₃/LiF/Al (35 nm/25 nm/6 nm/20 nm/1 nm/150 nm).

FIG. 5 is the ¹H-NMR spectrum of copolymer 14.

FIG. 6 is the ¹H-NMR spectrum of copolymer 15.

FIG. 7 is the ¹H-NMR spectrum of copolymer 16.

FIG. 8 is the ¹H-NMR spectrum of copolymer 17.

FIG. 9 is the device external quantum efficiency as a function of Iridium loading level for devices with structure ITO/24/16/BCP/LiF/Al (35 nm/25 nm/40 nm/2.5 nm/150 nm).

FIG. 10 is the EL spectra for OLED devices with structure ITO/24/16/BCP/LiF/Al (35 nm/25 nm/40 nm/2.5 nm/150 nm).

FIG. 11 is the current density, luminance and external quantum efficiency as a function of applied voltage for devices with structure ITO/24/22′/BCP/LiF/Al (35 nm/25 nm/40 nm/2.5 nm/150 nm).

FIG. 12 is the current density, luminance and external quantum efficiency as a function of applied voltage for devices with structure ITO/18/15/BCP/AlQ₃/LiF/Al (35 nm/25 nm/6 nm/20 nm/1 nm/150 nm).

FIG. 13 is the current density, luminance and external quantum efficiency as a function of applied voltage for devices with structure ITO/24/21′/BCP/LiF/Al (35 nm/25 nm/40 nm/2.5 nm/150 nm).

FIG. 14 is photoluminescence spectra for copolymer 21′.

FIG. 15 is photoluminescence spectra for copolymer 31′.

### DETAILED DESCRIPTION OF THE INVENTION

The present inventions are generally related to metal complexes, including the Iridium complexes described below, covalently bonded to poly(norbornene)s for use in the manufacture of light-emitting diodes, such as an organic light-emitting diode (OLED). The copolymerizable or copolymerized Iridium complexes have bidentate ligands and having the structure:

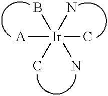

wherein the

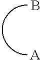

bidentate ligand is linked to a co-polymerizable norbornene monomeric group, or the corresponding copolymerized polynorbornenes.

The norbornene monomers comprising the emissive Iridium complexes can be co-polymerized via ring-opening metathesis polymerization (ROMP) with other norbornene co-monomers that comprise poly-unsaturated and polycyclic heteroaromatic “host” groups, “Rₕ”, that can conduct electrons and holes, i.e. exitons, to provide a solution processable copolymer “host material” with the metal complexes well dispersed and permanently bonded thereto.

ROMP is a living polymerization method resulting in polymers with controlled molecular weights, low polydispersities, and also allows for the formation of block co-polymers. See, for example, Fürstner, A. Angew. Chem., Int. Ed. 2000, 39, 3013; T. M. Trnka, T. M.; Grubbs, R. H. Acc. Chem. Res. 2001, 34, 18; Olefin Metathesis and Metathesis Polymerization, 2nd Ed.; Ivin, J., Mol, I. C., Eds.; Academic: New York, 1996; and Handbook of Metathesis, Vol. 3 —Application in Polymer Synthesis; Grubbs, R. H., Ed.; Wiley-VCH: Weinheim, 2003, each of which is respectively incorporated herein by reference in its entirety. Furthermore, ruthenium-based ROMP initiators (such as Grubb's third generation catalyst shown below) are highly functional-group tolerant, allowing for the polymerization of norbornene monomers containing fluorescent and phosphorescent metal complexes.

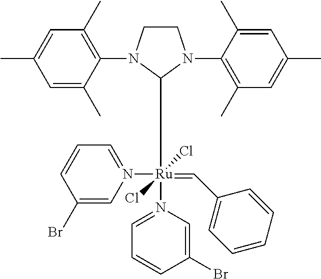

Grubb's 3d Generation ROMP Catalyst

In related aspects of the present inventions, novel copolymers containing host moieties that comprise both poly-unsaturated and polycyclic heteroaromatic “host” groups (such as for example 2,7-di(carbazol-9-yl)fluorene-type groups) and various iridium complexes in the side-chains are disclosed. Such copolymers (which can be either random or block copolymers) can have the structure:

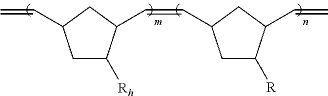

wherein Rₕ is a “host” group comprising poly-unsaturated and polycyclic heteroaromatic groups that are capable of conducting both holes and electrons, and R is a group linked to the phosphorescent metal complex, n is an integer from 5 to 30; and the ratio m:n can be from 70:30 to 95:5, can preferably be from 60:40 to 90:10.

Such copolymers can emit in various regions of the visible spectrum, depending upon the specific iridium complex employed. Such polymers can be solution processed and spin coated onto appropriate substrates, in the presence of crosslinking agents comprising cinnamate groups, and photo-patterned as part of the process of making OLEDs. In related aspects of the present invention, a novel OLED device is disclosed. Such OLED device comprises a poly(norbornene) having an iridium complex bound thereto.

Novel co-polymerizable norbornene compounds having iridium complexes bound thereto are described below in accordance with the present invention. Such novel copolymerizable compounds can have the following structure:

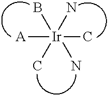

wherein the

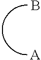

bidentate ligand is linked to a co-polymerizable norbornene monomeric group, or the corresponding copolymerized polynorbornenes.

Specific examples of the

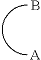

bidentate ligands linked to a co-polymerizable norbornene group include the 2-phenyl-pyridine compounds shown below:
is

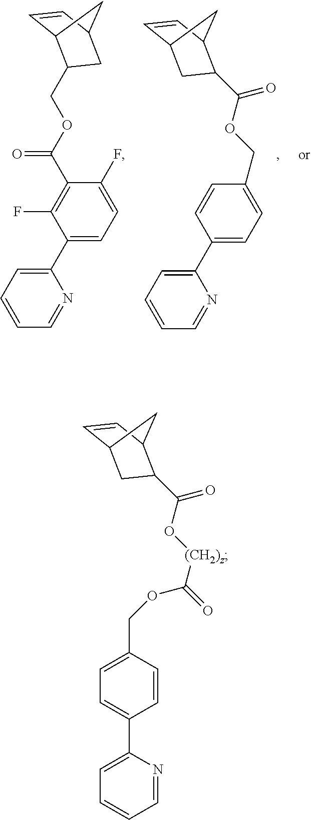

wherein z is an integer from 1 to 20, or 1 to 10. When such 2-phenyl-pyridines are reacted with certain pre-formed Iridium complexes that already comprise two

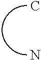

ligands, as further detailed below, and the Iridium coordinatively bonds to the pyridine nitrogen and simultaneously “oxidatively adds” to an ortho hydrogen on the phenyl ring, so that hydrogen is removed and an Ir-carbon bond is formed with the new ligand.

The two

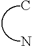

ligands of the monomeric or co-polymeric Iridium complexes can have variable structures that can contain a variety of optional peripheral substituents that can be used to “tune” the physical and phosphorescent properties of the resulting polymerizable Iridium complexes.

The structure of the two bidentate

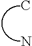

ligands for the Iridium complexes, either in the monomeric form or the co-polymeric form, include the 2-phenyl-pyridine ligands and close analog ligands shown below:

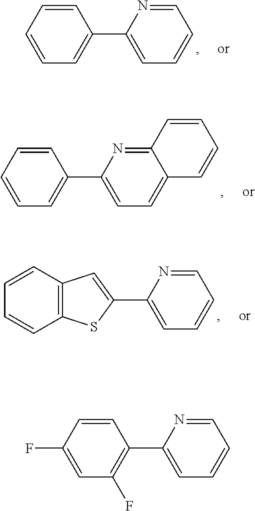

Moreover, the two

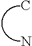

ligands for the Iridium complex can be optionally substituted with a variety of inorganic or organic substituent groups, as illustrated for example below;

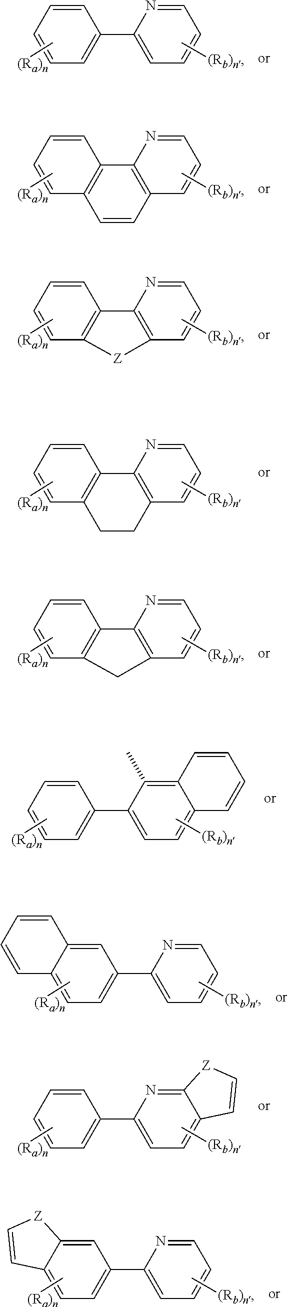

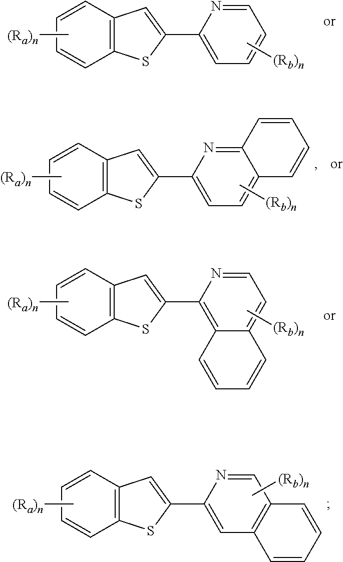

wherein Z is O or S,
and wherein n and n′ are integer indexes that can be the same or different and can have the values 0, 1, 2, or 3, with the proviso that at least one of n or n′ is not zero, and z is an integer from 1 to 20, or 1 to 10.

In such substituted precursors of bidentate ligands for Iridium atoms, the Rₐ and R_{b} group can be the same or different, and the ligand substituent groups can be varied so as to “tune” the emission wavelengths of the resulting Iridium complexes.

The Rₐ and R_{b} ligand substituent groups for the substituted

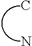

ligands can include a variety of inorganic substituent groups exemplified by hydroxy, sulfhydril, halo (F, Cl, Br, or I) nitro, —NH₂, —SO₃H, —SO₃⁻ salts (such as sodium, potassium, or lithium salts of the parent acid), —PO₃H₂, —PO₃H⁻ salts, —PO₃⁼ salts, and the like. The Rₐ and R_{b} ligand substituent groups can also be common C₁-C₄, C₁-C₈, or C₁-C₁₂, organic substituent groups. Examples of such Rₐ and R_{b} organic substituent groups include alkyl, alkoxy, hydroxyalkyl, alkoxyalkyl, —C(O)—Rₜ where Rₜ is alkyl or alkoxy, —O₂C—Rₜ where Rₜ is alkyl or alkoxy, —CO₂H or —CO₂⁻ salts, phenyl or phenyl substituted with additional small organic or inorganic substituent groups, furanyl or substituted furanyl, thiofuranyl or substituted thiofuranyl, —CN, perfluoroalkyl, perfluoroalkoxy, NHRₜ where Rₜ is alkyl or alkoxy, N(Rₜ)₂ where Rₜ is alkyl or alkoxy, —N═N—Rₜ where Rₜ is alkyl, alkoxy, or phenyl or substituted phenyl, —S—Rₜ where Rₜ is alkyl alkoxy or phenyl or substituted phenyl, or P(Rt)₃ wherein Rₜ is alkyl alkoxy or phenyl or substituted phenyl: or the like:

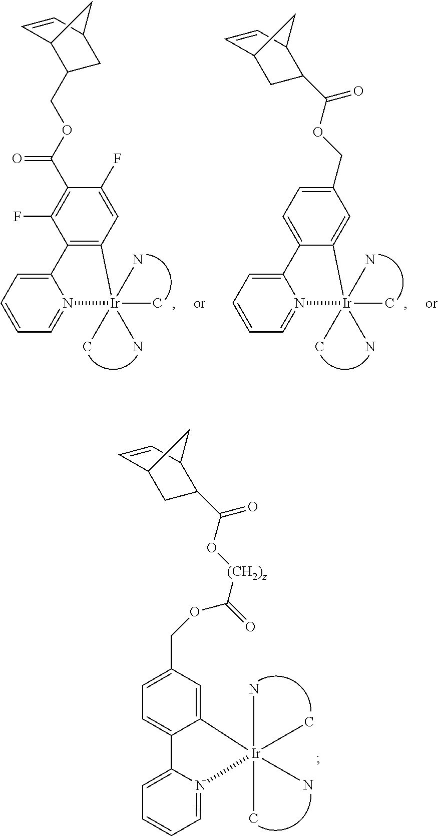

or substituted variations thereof, wherein z is an integer from 1 to 20, or 1 to 10,

The bidentate

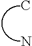

ligands can be 2-phenyl-pyridine or a substituted 2-phenyl pyridine, or a structural analog thereof, wherein the pyridine nitrogen atom is co-ordinatively bonded to the Iridium atom, and an ortho hydrogen from the adjacent phenyl (or analogous aromatic) group has been removed so that the phenyl ring forms a bond to the Iridiium, such as for example

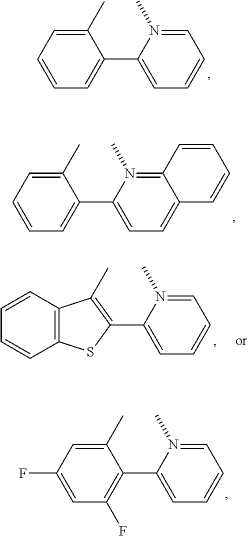

or substituted variations thereof, as disclosed herein.

The basic structures of the bidentate

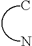

ligand can be varied by means of various substituent groups, in order to “tune” the physical and emission properties of the Iridium complex and/or related copolymer. Accordingly, in related aspect the invention provides for copolymerizable monomers and polymers as described herein wherein the bidentate

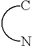

ligand bound to the Iridium complex has a substituted structure, such as for example

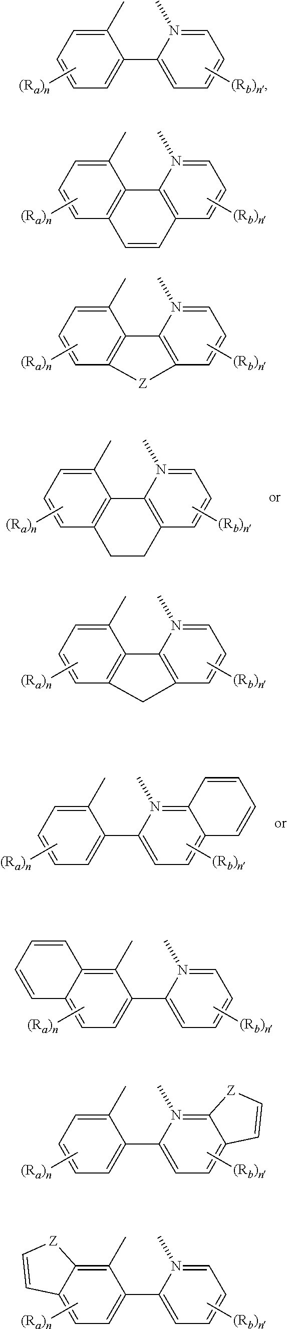

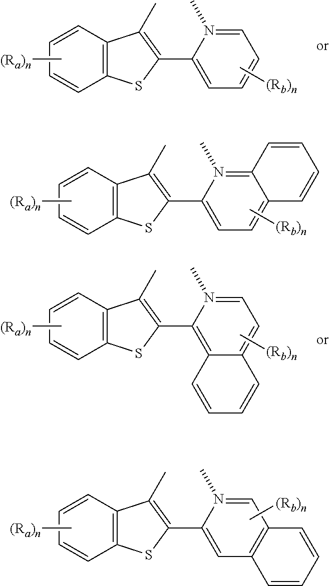

wherein Z is O or S,
and wherein n and n′ are integer indexes that can be the same or different and can have the values 0, 1, 2, or 3, with the proviso that at least one of n or n′ is not zero.

The ligand substituent groups Rₐ and R_{b} can be the same or different, and can be varied widely in both number, and in the specifics of the geometrical placement of the Rₐ and R_{b} substituent groups around the periphery of the rings of the potential bidentate ligand. Many suitable organic compounds are already commercially available, and a wide variety of methods for synthesizing additional corresponding substituted heterocylic organic compounds in a fashion analogous to Scheme I as described below are well known in the art of organic synthetic chemistry, and will not be further detailed herein.

The Rₐ and R_{b} ligand substituent groups can include for example inorganic substituents such as hydroxy (—OH), sulfhydril (—SH), halides, (F, Cl, Br, or I) nitro, —NH₂, —SO₃H, —SO₃⁻ salts (such as those comprising sodium, potassium, lithium, magnesium, or zinc or calcium cations, or the like), PO₃H₂, —PO₃H⁻ salts, —PO₃⁼ salts, and the like.

The Rₐ and R_{b} ligand substituent groups can include a wide variety of organic substituents that contain varying numbers of carbon atoms and molecular sizes, such as for example C₁-C₄, C₁-C₈, C₁-C₁₂ carbon atoms. Examples of suitable organic Rₐ and R_{b} substituents include for example alkyls (such as methyl, ethyl, n-or i-propyl and the like), alkoxy groups (such as methoxy or t-butoxy), hydroxyalkyls (such as hydroxyethyl groups), alkoxyalkyl (such as methoxyethyl groups), carboxylate esters such as —C(O)—Rₜ where Rₜ is alkyl or alkoxy, —O₂C—Rₜ where Rₜ is alkyl or alkoxy, —CO₂H or —CO₂⁻ salts, phenyl or substituted phenyl, furanyl or substituted furanyl, thiofuranyl or substituted thiofuranyl, —CN, perfluoroalkyl (such as trifluoromethyl), perfluoroalkoxy (such as trifluoromethoxy), monosubstituted amino groups such as —NHRₜ where Rₜ is alkyl or alkoxy, disubstituted amino groups such as N(Rₜ)₂ where Rₜ is allyl or alkoxy, azo groups —N═N—Rₜ where Rₜ is alkyl, alkoxy, or phenyl or substituted phenyl, thioethers such as —S—Rₜ where Rₜ is alkyl alkoxy or phenyl or substituted phenyl, or phosphine groups such as P(Rt)₃ wherein Rₜ is alkyl alkoxy or phenyl or substituted phenyl: or the like.

Examples of such copolymerizable compounds are described in the examples below and include:

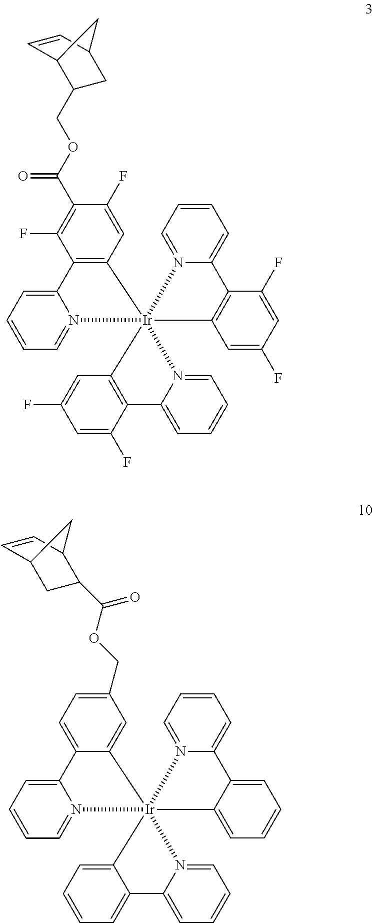

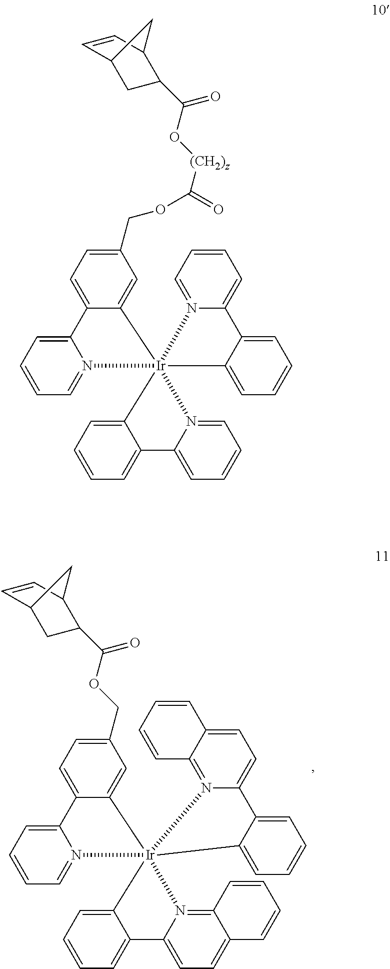

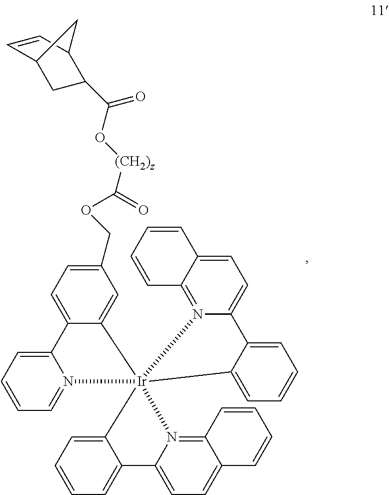

Compounds 3 and 10-12′, and similar compounds can be made in accordance with Scheme 1 as follows:

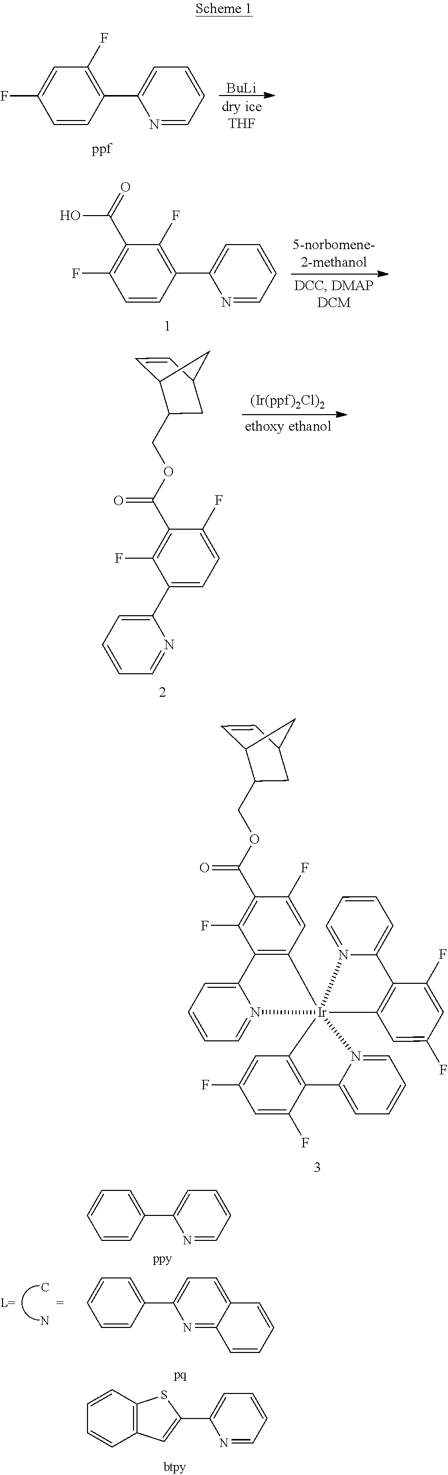

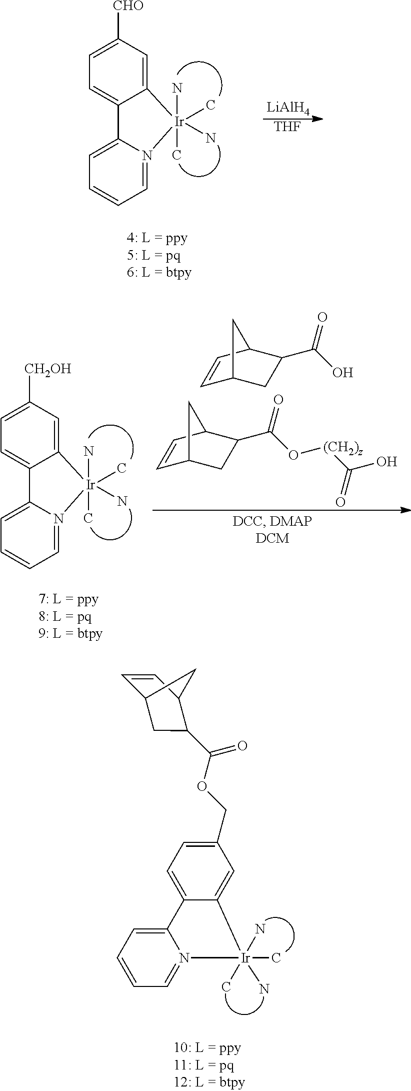

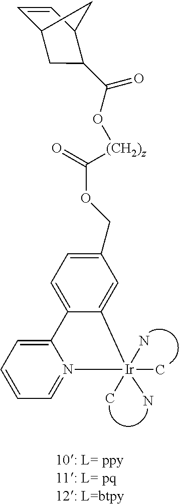

The coupling of 2-phenyl-pyridine (ppy) to exo-norbornene carboxylic acids is employed in the synthesis of the iridium complex-based monomers 10-12′. The emission color of the iridium complexes, and, therefore, the monomers and polymers, can be tuned through variation of the ligand. In Scheme 1,2-phenyl-pyridine, 2-phenylquinoline (pq), or 2-benzo[b]thiophen-2-yl-pyridine (btpy) can be respectively employed as the ligands. This synthetic strategy was not applied to the synthesis of a blue/green-emitting monomer based on the 2-(2,4-difluoro-phenyl)pyridinato (ppf) ligand. Accordingly, monomer 3 comprising three ppf-type ligands was synthesized according to the route shown in Scheme 1 and as described in Example 3 below.

In another aspect of the present invention, novel compounds having iridium complexes have the following structure:

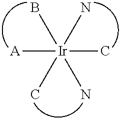

wherein:

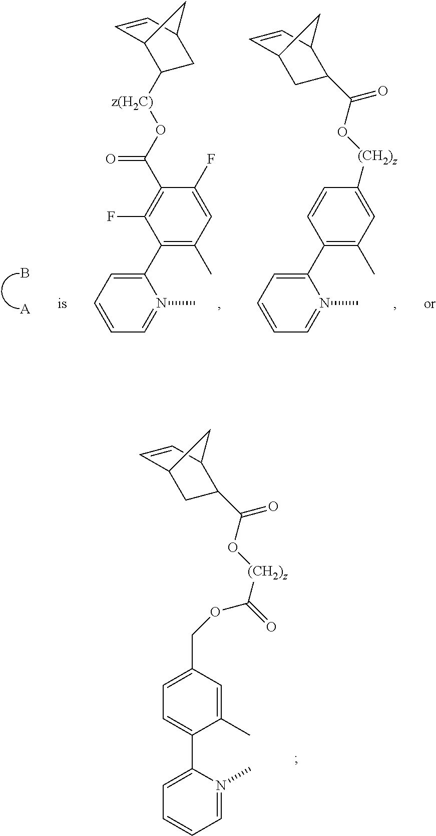

z is an integer from 1 to 10; and

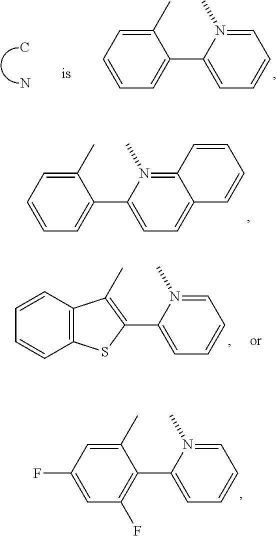

wherein the

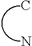

ligand is the same in each instance for the respective compound and can be optionally substituted as described hereing, and z is an integer from 1 to 10.

In related aspects, the invention relates to norbornene co-monomers that comprise poly-unsaturated and polycyclic heteroaromatic “host” group side chains “Rₕ” that are capable of conducting holes and, electrons, so that the holes and electrons, and/or exitons are transported into contact with the Iridium complexes described above, so as to cause the formation of excited states of the Iridium complexes.

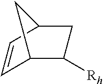

The norbornene co-monomers that comprise such “Rₕ” “host” group side chains typically contain poly-unsaturated and polycyclic heteroaromatic groups that are chosen for their ability to conduct both holes and electrons efficiently, in order to provide for electrical pathways to excite the emitter. Through the electrical conduction of both holes and electrons, the host groups Rₕ can transport the holes and electrons provided by the adjacent hole and electron transport layers to the phosphorescent metal complex dispersed in the emissive layer. These holes and electrons transferred by the Rₕ host groups to the phosphorescent Iridium complexes that are also bound to the copolymers described below, so as to allow the Iridium complexes to form excited states from which the recombination to the ground state provides for light emission. Excited states of the phosphorescent metal complex can also be formed by other means by which excited states of the host are first formed and then transferred to the phosphorescent metal complex dispersed into the host by two different energy transfer mechanisms that are well known in the art. A first energy transfer mechanism referred to as Förster energy transfer allows singlet excited states of the host to be transferred to the singlet excited state of the phosphorescent metal complex which is converted into an excited state from which phosphorescent emission is observed by a process called inter-system crossing. A second energy transfer mechanism referred to as Dexter energy transfer allows for non-emissive excited states of the host to be transferred directly to the excited state of the phosphorescent metal complex from which phosphorescent emission is observed. For these energy transfer processed to be efficient, the energies of the singlet and triplet states of the host material or molecule are chosen to be larger than those of the singlet and phosphorescent excited states of the phosphorescent Iridium complex.

Because the energies of the excited states of the Iridium complexes can vary as described herein, the structures of the Rₕ poly-unsaturated and polycyclic heteroaromatic groups must also be varied, so as to maintain the necessary condition that the energies of the singlet and triplet states of the host material or molecule are chosen to be larger than those of the singlet and phosphorescent excited states of the phosphorescent Iridium complex. One of ordinary skill in the art will recognize that a wide variety of structures of such Rₕ poly-unsaturated and polycyclic heteroaromatic groups could be considered. Examples of such substituted Rₕ groups include the following:

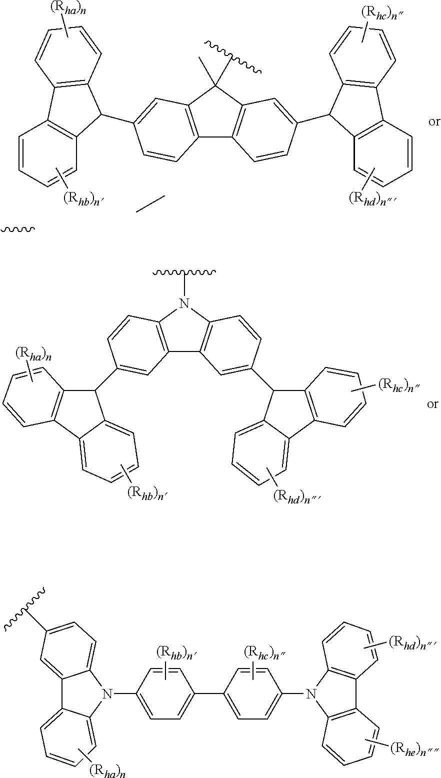

wherein n, n′, n″, n′″, and n″″ are integer indexes that can be the same or different and can have the values 0, 1, 2, or 3. The Rₕₐ, R_{hb}, R_{hc}, R_{hd}, and Fₕₑ, ligand substituent groups can include for example inorganic substituents such as hydroxy (—OH), sulfhydril (—SH), halides, (F, Cl, Br, or I) nitro, —NH₂, —SO₃H, —SO₃⁻ salts (such as those comprising sodium, potassium, lithium, magnesium, or zinc or calcium cations, or the like), —PO₃H₂, —PO₃H⁻ salts, —PO₃⁼ salts, and the like.

The Rₕₐ, R_{hb}, R_{hc}, R_{hd}, and Rₕₑ, ligand substituent groups can also include a wide variety of organic substituents that contain varying numbers of carbon atoms and molecular sizes, such as for example C₁-C₄, C₁-C₈, C₁-C₁₂ carbon atoms. Examples of suitable organic Rₐ and R_{b} substituents include for example alkyls (such as methyl, ethyl, n-or i-propyl and the like), alkoxy groups (such as methoxy or t-butoxy), hydroxyalkyls (such as hydroxyethyl groups), alkoxyalkyl (such as methoxyethyl groups), carboxylate esters such as —C(O)—Rₜ where Rₜ is alkyl or alkoxy, —O₂C—Rₜ where Rₜ is alkyl or alkoxy, —CO₂H or —CO₂⁻ salts, phenyl or substituted phenyl, furanyl or substituted furanyl, thiofuranyl or substituted thiofuranyl, —CN, perfluoroalkyl (such as trifluoromethyl), perfluoroalkoxy (such as trifluoromethoxy), monosubstituted amino groups such as —NHRₜ where Rₜ is alkyl or alkoxy, disubstituted amino groups such as N(Rₜ)₂ where Rₜ is alkyl or alkoxy, azo groups where Rₜ is alkyl, alkoxy, or phenyl or substituted phenyl, thioethers such as —S—Rₜ where Rₜ is alkyl alkoxy or phenyl or substituted phenyl, or phosphine groups such as P(Rt)₃ wherein Rₜ is alkyl alkoxy or phenyl or substituted phenyl: or the like.

Examples of such co-monomers comprising poly-unsaturated and polycyclic heteroaromatic “host” groups “Rₕ” include those shown below, or optionally substituted variations thereof, as further disclosed hereinbelow:

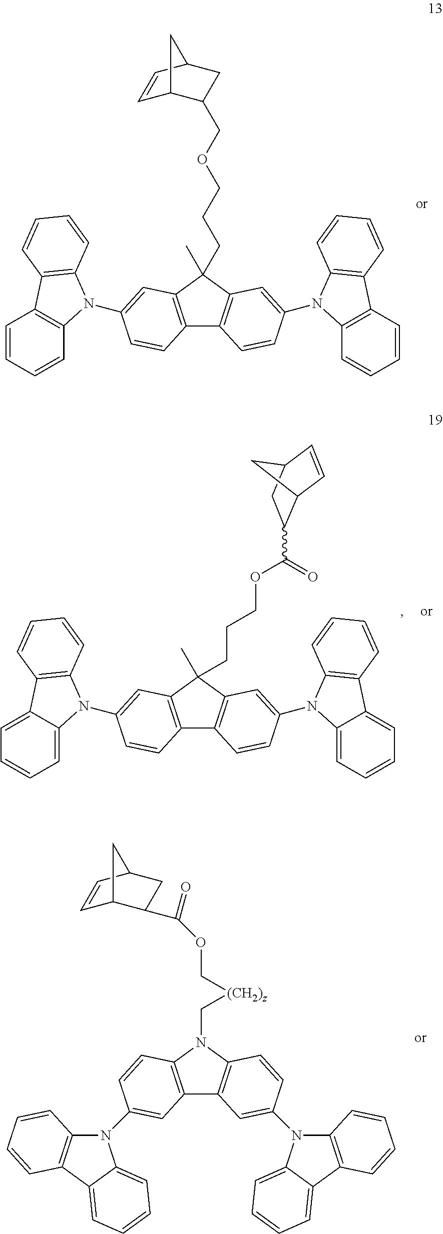

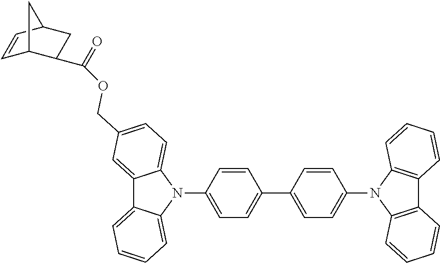

An example of the synthesis of compound 19 disclosed above is provided in Example 12 below. Compound 13 can be prepared analogously by the synthetic procedure outlined in the scheme below:

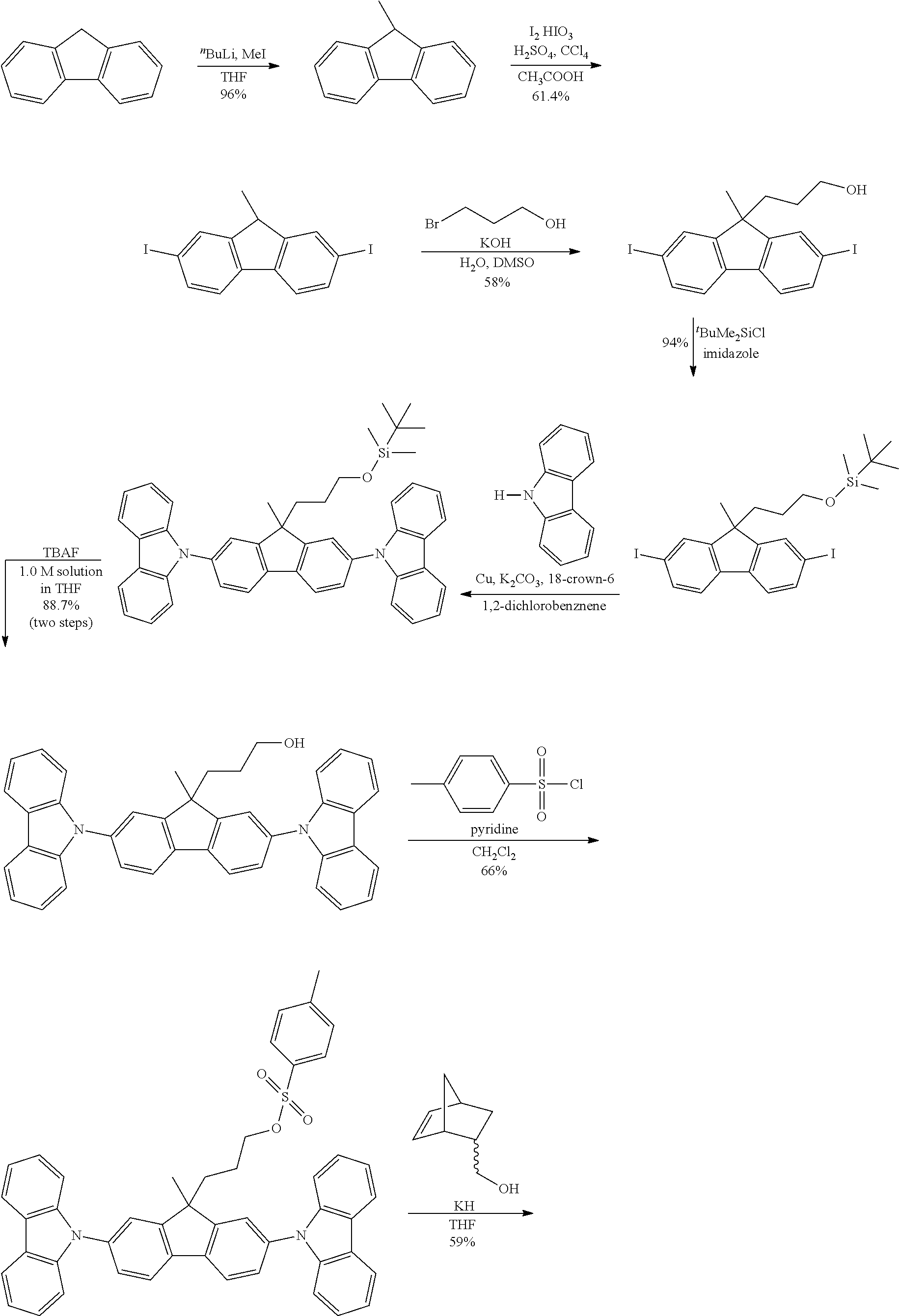

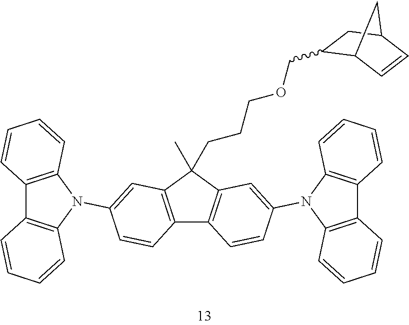

### Synthesis of 9-[3-(bicyclo[2.2.1]hept-5-en-2-ylmethoxy)-propyl]-2,7-bis-carbazol-9-yl-9-methyl-9H-fluorene (13)

A synthesis of the heterocyclic portion of the Rh group shown below:

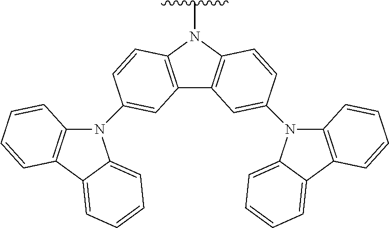

was described in U.S. Patent Publication 2004/0247933, hereby incorporated by reference herein in it's entirety, and the resulting heterocycle can be tethered to norbornyl groups by methods analogous to those described above, i.e. by reaction of the secondary amine group with 3-bromopropanol, etc., or other longer chain variations can be synthesized as shown below:

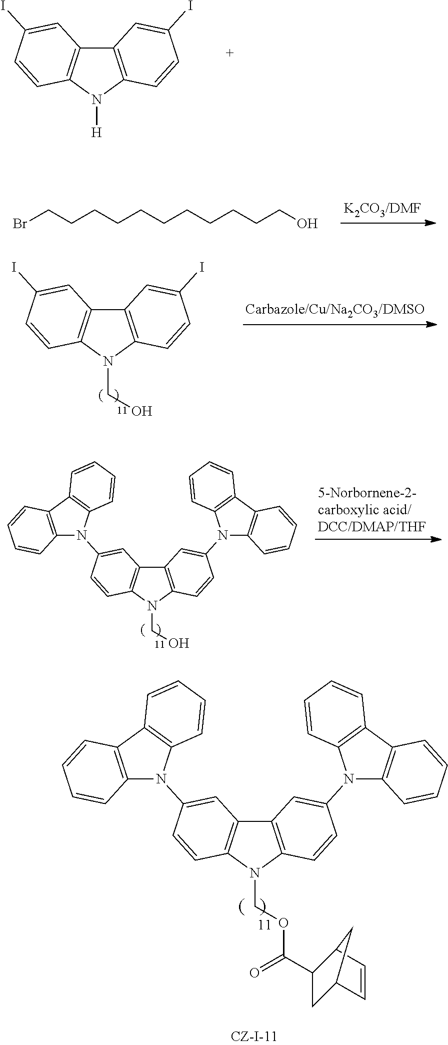

Additional norbornyl comonomers can be synthesized as shown below:

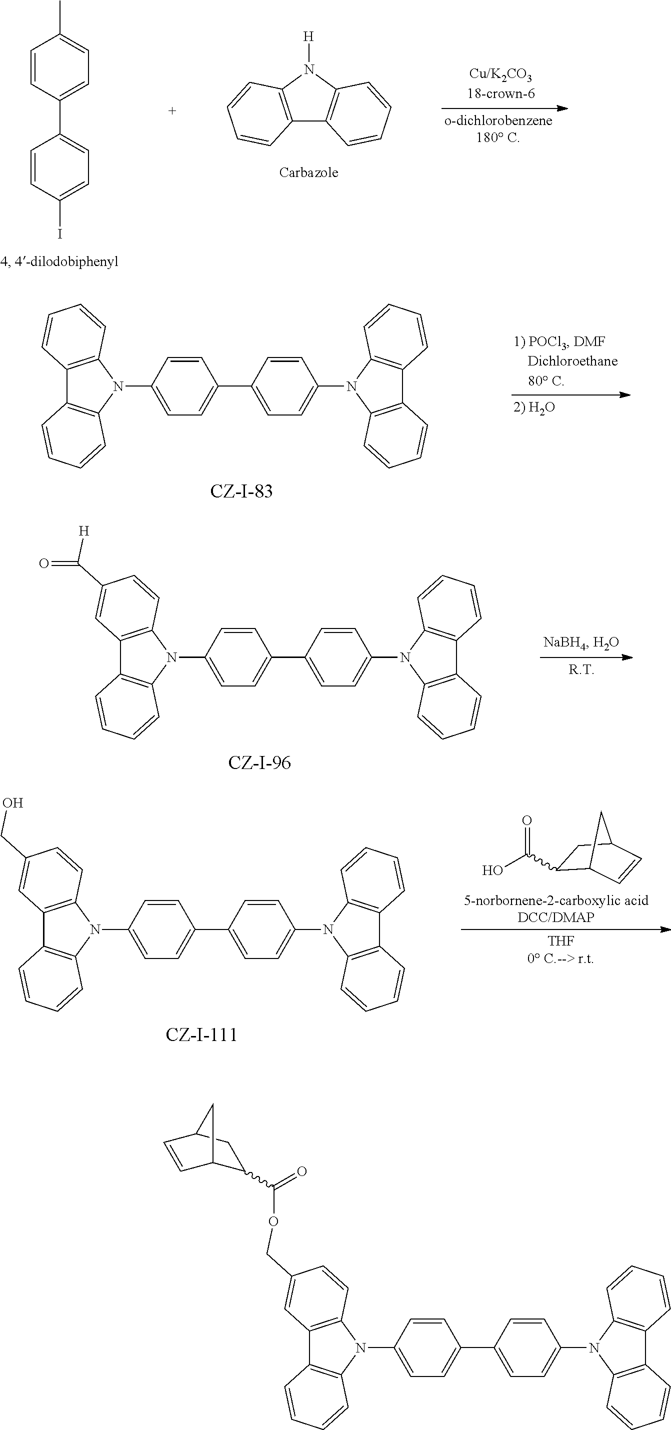

In another aspect of the present invention, novel poly(norbornene)s are described below in accordance with the present inventions. Host groups are covalently linked to the polymer backbone along with the emissive compound, combining the properties of both in a single material by copolymerizing two functional monomers randomly in a controlled fashion. Such novel poly(norbornene)s have the following structure:

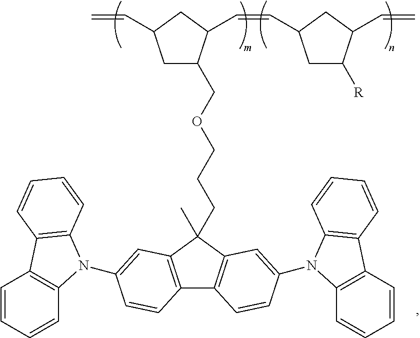

wherein:
n is an integer from 5 to 30;

### R is

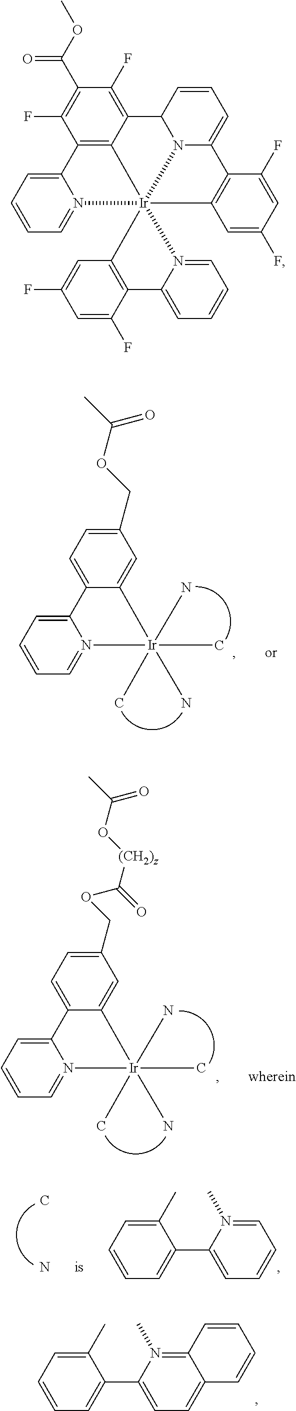

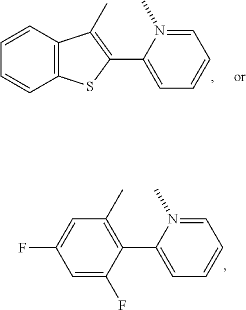

wherein the

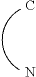

ligand can be optionally substituted as disclosed above, and is the same in each instance for the respective compound and z is an integer from 1 to 10 or 1 to 20.

In the present inventions, the copolymerizable norbonene comprising an Rₕ “host” group can be a 2,7-di(carbazol-9-yl)fluorene-based such as monomer 13 as illustrated in Scheme 2 as follows:

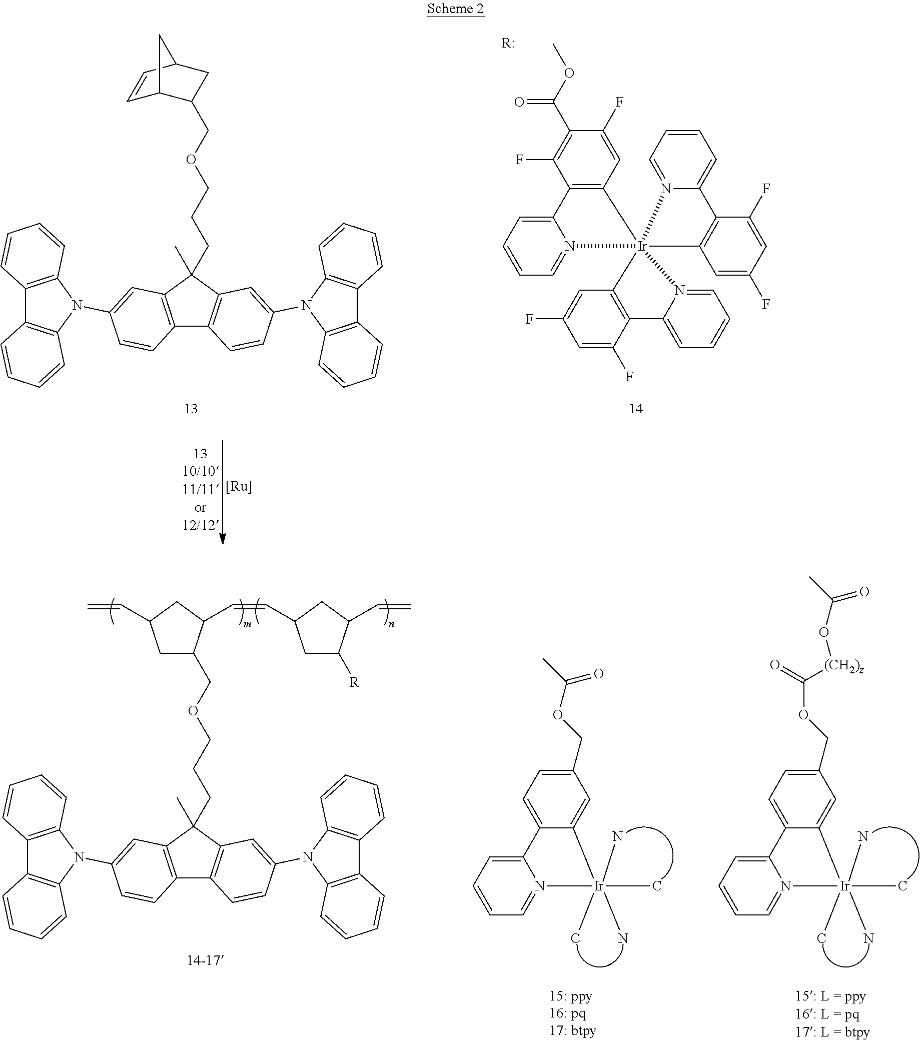

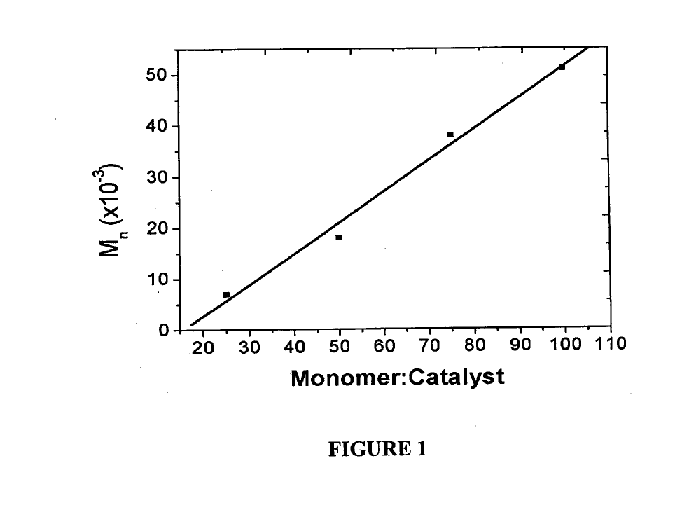

A living polymerization provides for the successful reproducibility of all desired copolymers. Therefore, the living character of the homopolymerization of 13 was verified. Four different polymerization reactions were carried out with monomer to catalyst ratios of 25:1, 50:1, 75:1, and 100:1 using Grubbs' third generation initiator. See Love, J. A.; Morgan, J. P.; Trnka, T. M.; Grubbs, R. H. Angew. Chem., Int. Ed. 2002, 41, 4035, which is incorporated herein by reference in its entirety. FIG. 1 shows the plot of the molecular weights of these homopolymers versus the monomer to catalyst ratios. The linear relationship indicates that the polymerization is controlled. Furthermore, ¹H-NMR spectroscopy experiments showed the complete disappearance of the carbene signal of the initiator around 19.1 ppm, and the formation of a new, broad carbene signal around 18.5 ppm, indicating complete initiation. Both experiments strongly suggest that the polymerization of 13 proceeds in a living fashion.

Attempts to investigate the living character of the homopolymerization of 3, and 10-12 were not possible because the addition of the ruthenium initiator to the monomer solutions resulted in precipitation of insoluble materials. Therefore, in the present invention, comonomer 13 also serves as a spacer and solubilizing unit between the metal complexes in addition to its role in accepting electrons and holes.

In another aspect of the present invention, polymers can be made in accordance with Scheme 3 below. Polymers 20-23′ are produced in the same manner as Scheme 2, with the exception that compound 13 is substituted with compound 19.

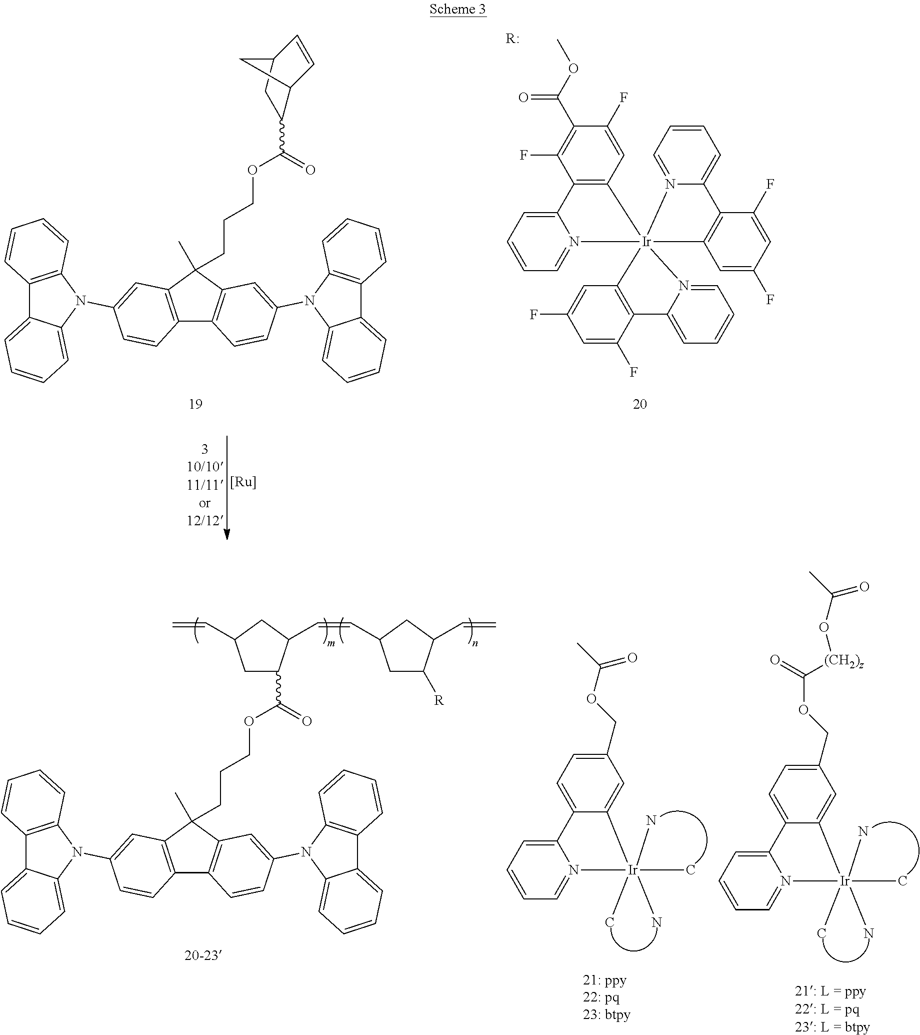

Yet, in another aspect, the present invention is directed to a polymer having the formula:

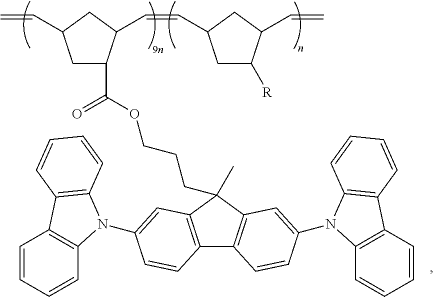

wherein:
n is an integer from 5 to 30, and m:n is 70:30 to 95:5;

### R is

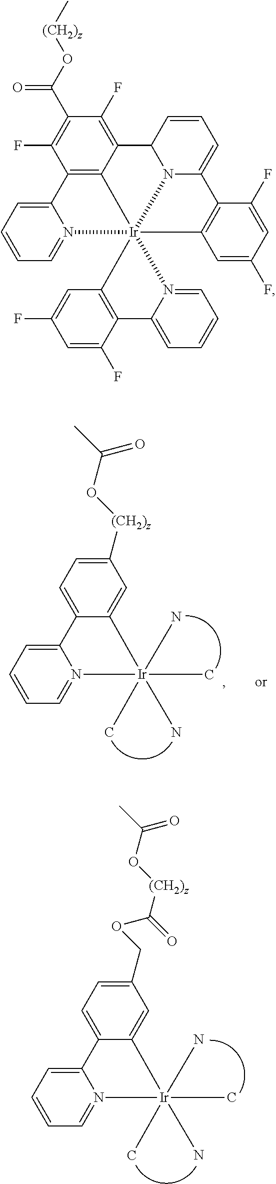

wherein z is an integer from 1 to 10 or 1 to 20;

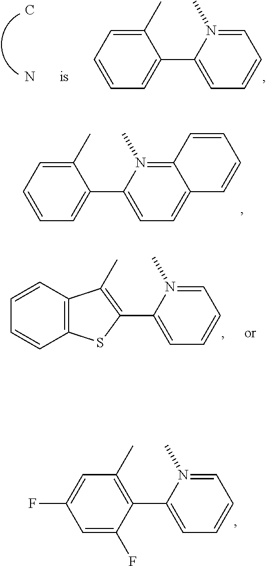

wherein the

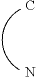

ligand can be optionally substituted as described herein and is the same in each instance for the respective compound.

In another aspect, the polymers have the structure

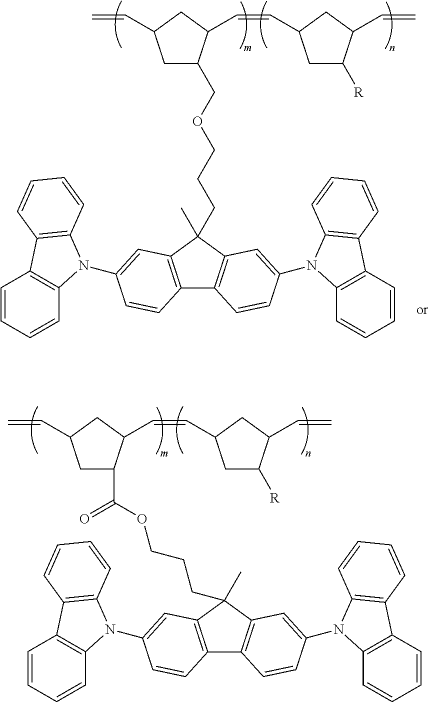

wherein R is

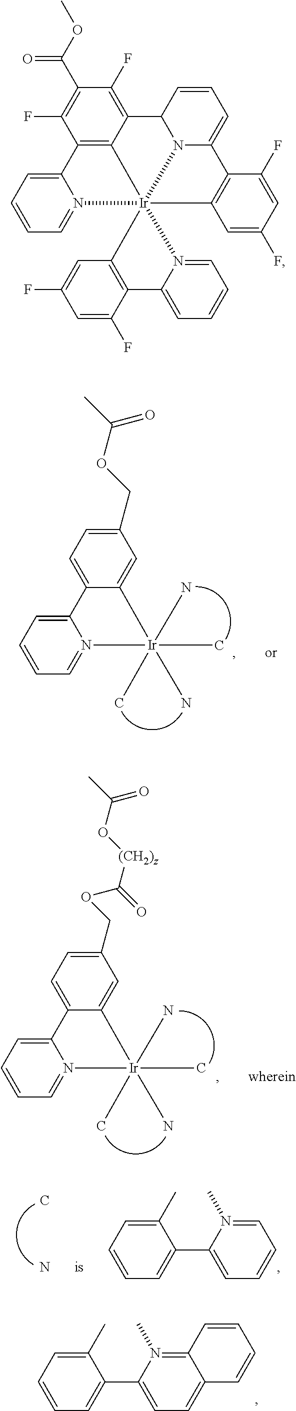

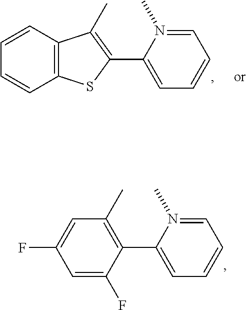

wherein the ligand

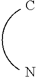

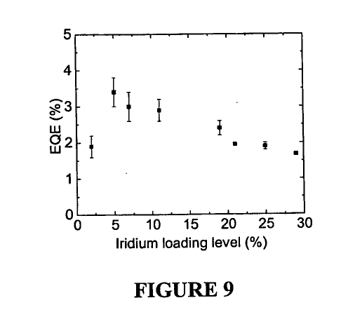

can be optionally substituted as described elsewhere herein, and is the same in each instance for the respective compound, z is an integer from 1 to 10, or 1 to 20, m:n is 70:30 to 95:5. Physical data for examples of these polymers are given in Table 3 and FIG. 9-11.

In another aspect, the present invention is directed to a polymer having the formula:

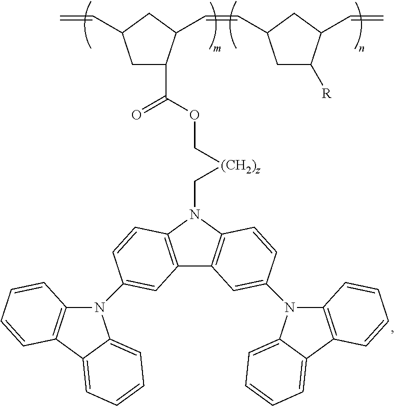

wherein:
n is an integer from 5 to 30; and m:n is 70:30 to 95:5. and

### R is

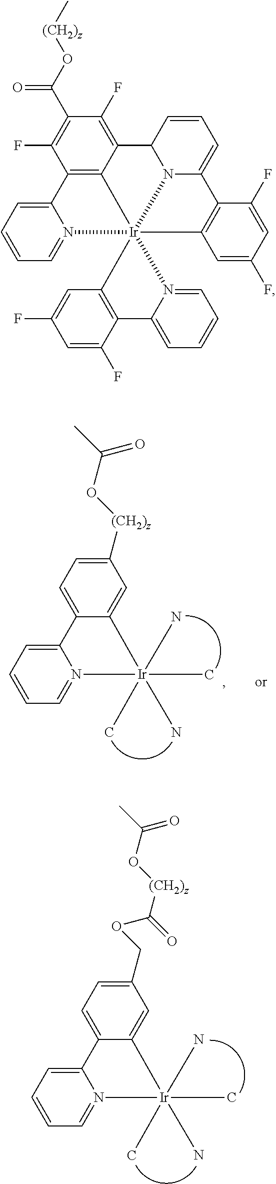

and z is an integer from 1 to 10, or 1 to 20;

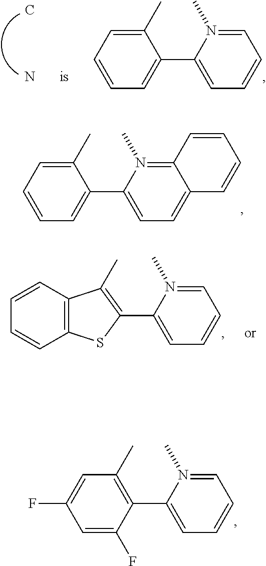

wherein the

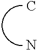

ligand can be optionally substituted as described elsewhere herein, and is the same in each instance for the respective compound.

The copolymers (30-33′) may be prepared from 29 and 10-12′ as outlined below:

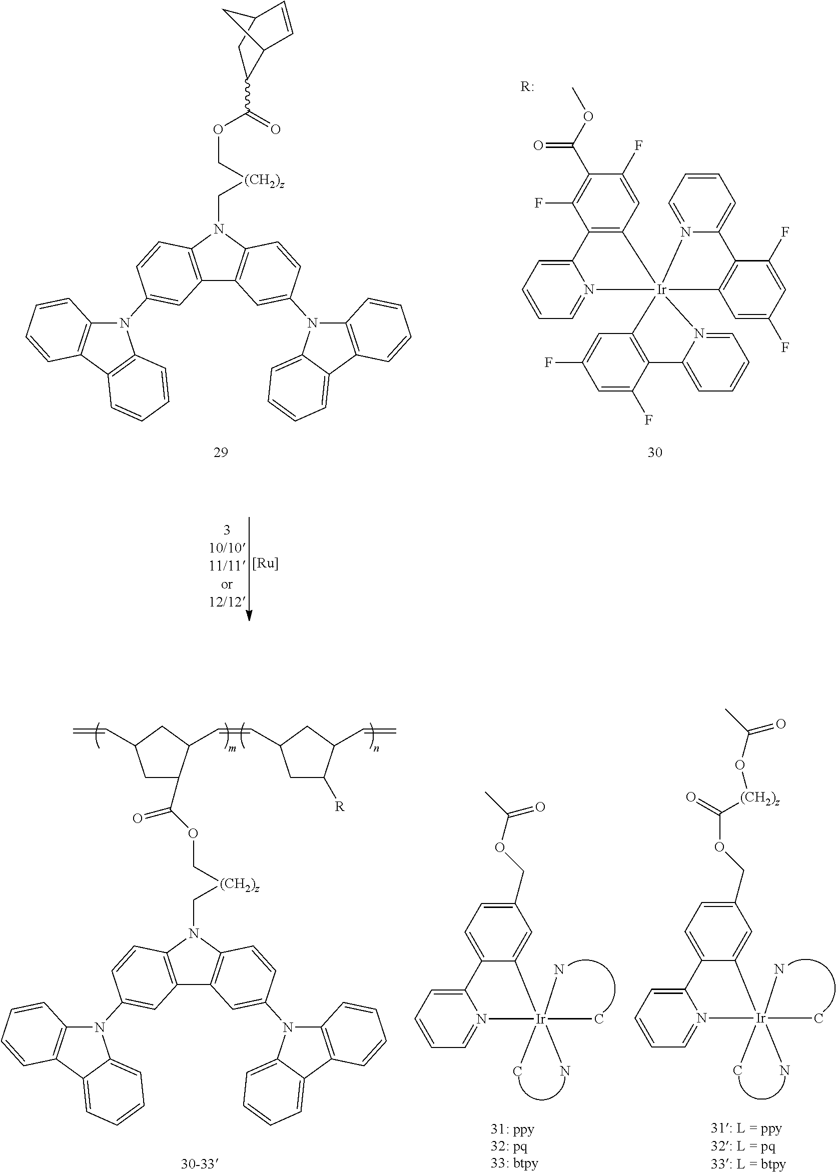

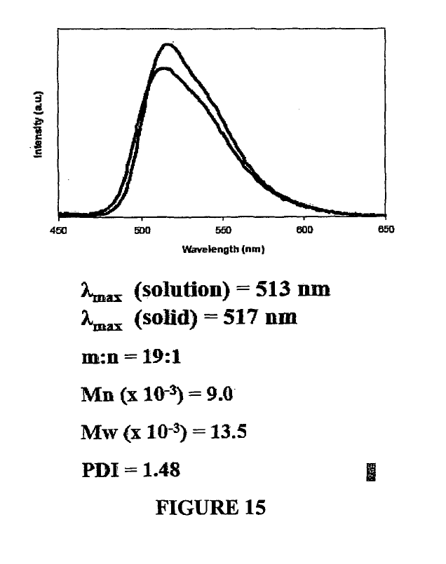

Physical data for an example of these copolymers is shown in FIG. 15.

Polymer Properties

Table 1 lists the polymer properties of copolymers 14-17. All copolymers have molecular weights around 20 kD and polydispersities between 1.22 and 1.31. The low polydispersity indices (PDIs) of the copolymers indicate a high degree of control of the polymerizations and ensure that the approximate lengths of the polymer chains are reproducible, minimizing potentially adverse effects of chain length differences on device performance. Glass-transition temperatures were not observed for any of the copolymers. All copolymers underwent 5% weight loss at temperatures slightly higher than 300° C. as measured by thermal gravimetric analysis.

Photophysical Properties

The photophysical and electroluminescence properties of the small molecule analogues of the iridium complexes of the present invention and devices based on these complexes are described in the literature. Therefore, the basic photophysical properties of the copolymers of the present invention were compared to their small molecule analogues to evaluate their potential as materials for OLEDs. Table 2 lists the photophysical properties of copolymers 14-17. In solution, the high-energy regions of the absorption spectra of the copolymers are dominated by monomer 13 since its concentration is nine times higher than those of the iridium complex-containing monomers. Thus, the ligand-centered (LC) π-π* transitions typically observed for iridium complexes in the region of 250-350 nm are obscured by transitions attributable to 13 at around 295 nm and 340 nm. In the lower energy region, starting around 380 nm, broad features assignable to metal-to-ligand charge transfer (MLCT) transitions of the iridium complexes are observed.

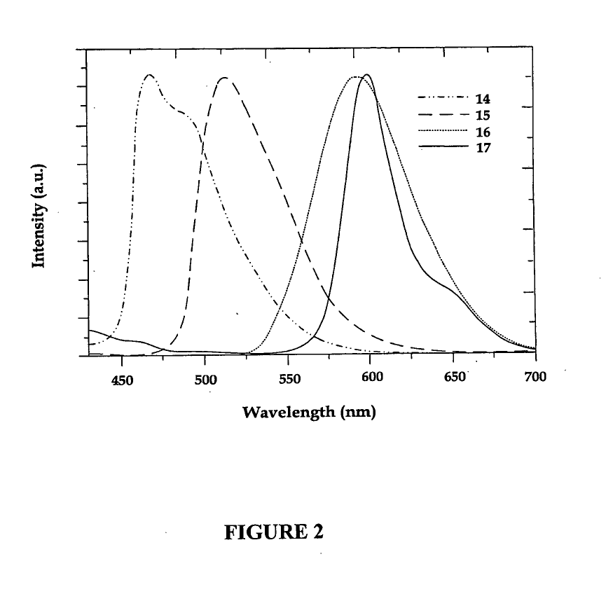

The solid-state emissions of the copolymers of the present invention are slightly red shifted compared to the solution emissions with the exception of 17. FIG. 2 shows the solid-state emission spectra of copolymers 14-17. The tunability of the emission of cyclometallated iridium species is well established; relative to Ir(ppy)₃, a blue-shifted emission can be obtained by employing electron-withdrawing groups such as fluorine, while the emission of the complexes with extended conjugation is red-shifted. The shapes of the peaks and the emission maxima of copolymers 14-17 are identical to those of the corresponding small-molecule iridium complexes, indicating that polymer backbones do not interfere with the emission.

The solution phosphorescence quantum efficiencies of 14-17 were measured using fac-Ir(ppy)₃ as reference (Φ=0.40, in toluene) and range from 0.07 to 0.41. The emission lifetimes are strongly affected by the presence of oxygen due to the quenching of the ³MLCT state by oxygen. See, for example, Fluorescence and Phosphorescence Analysis: Principles and Applications; Hercules, D. M.; Interscience Publishers, New York, 1966, which is incorporated herein by reference in its entirety. In degassed solutions, the lifetimes are in the microsecond region. The measured values of the emission efficiencies and the lifetimes are comparable to those of the corresponding small-molecule complexes.

Device Fabrication

TPD-based acrylate copolymers, such as N4,N4′-diphenyl-N4,N4′-di-m-tolylbiphenyl-4,4′-diamine acrylate copolymers 18 (shown below), containing 20 mol % of a cinnamate crosslinking moiety are known in the literature and can be used to photo-crosslink the copolymers described herein in the emissive layer, or can be used to form hole-transport materials and layers. Uses of such TPD-based acrylate copolymers are discussed in Zhang, Y.-D.; Hreha, R. D.; Domercq, B.; Larribeau, N.; Haddock, J. N.; Kippelen, B.; Marder, S. R. Synthesis 2002, 1201 and Domercq, B.; Hreha, R. D.; Zhang, Y.-D.; Larribeau, N.; Haddock, J. N.; Schultz, C.; Marder, S. R.; Kippelen, B. Chem. Mater. 2003, 15, 1491, both of which are incorporated herein by reference in their entirety.

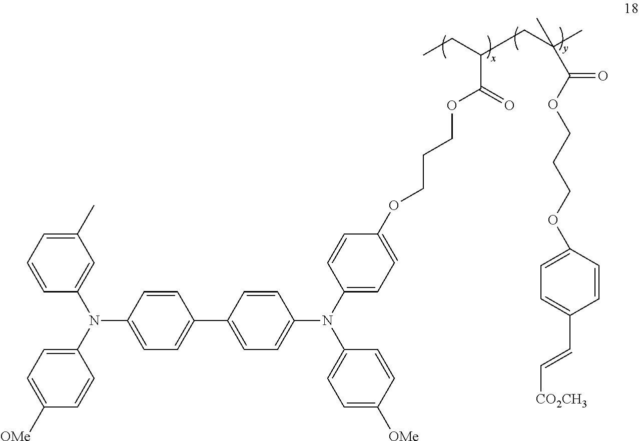

wherein x and y are integers and the ratio of x:y is 4:1, and x is an integer between 5 and 50,000.

Films of 35 to 40 nm thickness were prepared by spin coating solutions of 18 onto oxygen plasma treated indium tin oxide (ITO) with a sheet resistance of 20Ω/□ (Colorado Concept Coatings, L.L.C.) from toluene solutions of the polymer. 1 minute of ultraviolet radiation (UV) exposure using a standard broad-band UV light with a 0.6 mW/cm² power density was used to cross-link the hole-transport polymer. For the respective OLED's, the emissive copolymers (14, 15, 16, and 17) were then spin-coated from their chloroform solutions onto the cross-linked hole-transport layer to form respective films with a thickness of 20-30 nm. Electron-transport and hole-blocking layers comprised of a 20 nm-thick film of aluminum tris(8-hydroxy quinoline) (AlQ₃) and a 6 nm-thick film of 2,9-dimethyl-4,7-diphenyl-1,10-phenanthroline (also referred to as “bathocuproine” (BCP)), respectively, were thermally evaporated at rates between 0.4 and 0.7 Å/s under a pressure below 1×10⁻⁷ Torr on top of the emitting layer. LiF (1 nm) and the metal cathode Al (150 nm) were deposited through a shadow mask to define five devices per substrate with an emissive area of 0.1 cm² each.

Electroluminescence Properties and Device Performance

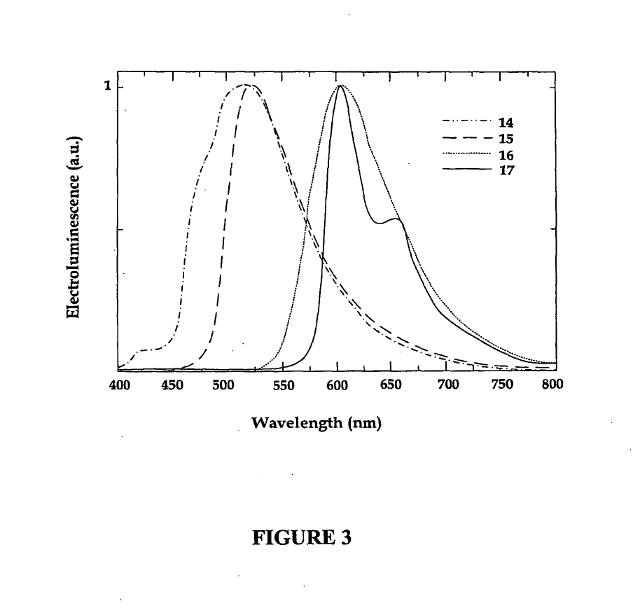

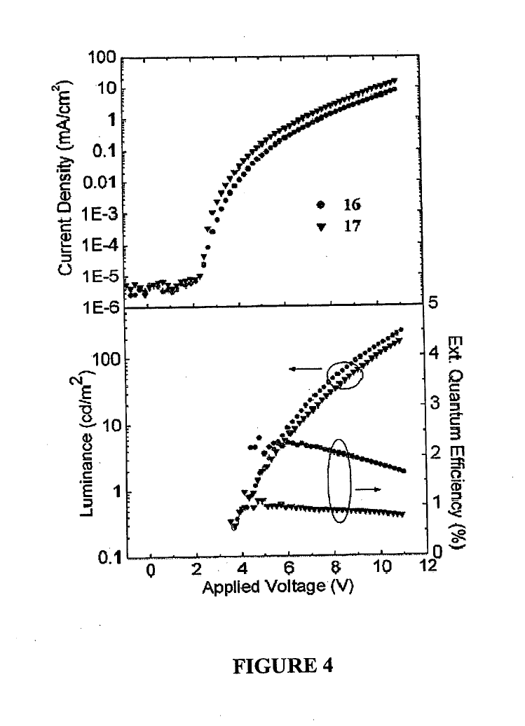

FIG. 3 illustrates the electroluminescence spectra of devices in which the copolymers 14-17 were used as emitting layers between the cross-linked TPD-based copolymer 18 as the hole-transport material and vacuum-deposited BCP and AlQ₃ as hole-blocking and electron-transport materials, respectively. Devices fabricated using copolymers 14-17 show electroluminescence spectra with emission maxima that are similar to those measured in photoluminescence experiments performed in solid-state (see FIG. 2) suggesting that the emission stems from the iridium complex. The electroluminescence (EL) spectrum of devices fabricated using copolymer 14 shows a shift towards longer wavelengths with a maximum at 511 nm compared to a maximum of 465 nm in photoluminescence spectra. FIG. 4 illustrates the electrical characteristics of devices fabricated using copolymer 16 and 17 as emitting layers. Current density as a function of applied voltage shows a leak-free behavior at low voltage and could be measured over 6 orders of magnitude. The turn-on voltage for the current density is low (ca. 2.4 V) for both devices, and the turn-on voltage for the light for both devices is 3.7 V. External quantum efficiencies at 100 cd/m² are 1.9 and 0.9% for devices fabricated using copolymer 16 and 17, respectively. These results are encouraging given the low photoluminescence quantum efficiency of these two copolymers (10 and 7% for copolymers 16 and 17, respectively) compared to that of Ir(ppy)₃ (40%). Devices fabricated from copolymers 14 and 15 yielded low light output. This behavior may be due to less efficient triplet energy transfer from the host material in the copolymer to phosphorescent moieties with longer wavelength emission.

The above specification, examples and data provide a complete description of the manufacture and use of the composition of the invention. Since many embodiments of the invention can be made without departing from the spirit and scope of the invention, the invention resides in the claims hereinafter appended.

### EXAMPLES

The present invention is further illustrated by the following examples, which are not to be construed in any way as imposing limitations upon the scope thereof. On the contrary, it is to be clearly understood that resort may be had to various other embodiments, modifications, and equivalents thereof which, after reading the description herein, may suggest themselves to one of ordinary skill in the art without departing from the spirit of the present invention or the scope of the appended claims.

For the following examples, all reagents were purchased either from Acros Organics or Aldrich and used without further purification unless otherwise noted. Bathocuproine (2,9-dimethyl-4,7-diphenyl-1,10-phenanthroline, BCP) and tris(8-hydroxyquinolinato) aluminum (AlQ₃) were purchased from Aldrich and purified by gradient sublimation prior to use. Lithium fluoride and Aluminum (99.999%) were purchased from Alfa Aesar and used as received. ¹H-NMR and ¹³C-NMR spectra (300 MHz ¹H NMR, 75 MHz ¹³C NMR) were obtained using a Varian Mercury Vx 300 spectrometer. All spectra are referenced to residual proton solvent. Abbreviations used include singlet (s), doublet (d), doublet of doublets (dd), triplet (t), triplet of doublets (td) and unresolved multiplet (m). Mass spectral analyses were provided by the Georgia Tech Mass Spectrometry Facility. Gel-permeation chromatography (GPC) analyses were carried out using a Waters 1525 binary pump coupled to a Waters 2414 refractive index detector with methylene chloride as the eluant on American Polymer Standards 10 μm particle size, linear mixed bed packing columns. The flow rate used for all the measurements was 1 mL/min. All GPC measurements were calibrated using poly(styrene) standards and carried out at room temperature. The onset of thermal degradation for the polymers was measured by thermal gravimetric analysis (TGA) using a Shimadzu TGA-50. UV/vis absorption measurements were taken on a Shimadzu UV-2401 PC recording spectrophotometer. Emission measurements were acquired using a Shimadzu RF-5301 PC spectrofluorophotometer. Lifetime measurements were taken using a PTI model C-72 fluorescence laser spectrophotometer with a PTI GL-3300 nitrogen laser. Elemental analyses for C, H, and N were performed using Perkin Elmer Series II CHNS/O Analyzer 2400. Elemental analyses for iridium were provided by Galbraith Laboratories.

Compound 1 was obtained by taking advantage of the most acidic hydrogen in the benzene ring of ppf through the reaction of ppf with BuLi, followed by treatment with CO₂ (Scheme 1). See, for example, Schlosser, M.; Heiss, C. Eur. J. Org. Chem. 2003, 4618; Coe, P. L.; Waring, A. J.; Yarwood, T. D. J. Chem. Soc. Perkin Trans. 1 1995, 2729; and Bridges, A. J.; Patt, W. C.; Stickney, T. M. J. Org. Chem. 1990, 55, 773, each of which respectively is incorporated herein by reference in its entirety. Coupling of 1 to 5-norbornene-2-methanol yielded 2, which was metalated to yield the Ir(ppf)₃-based monomer 3. Complex 6 was synthesized by the reaction of the iridium dimer (Ir(btpy)₂Cl)₂ with 4-(2-pyridine)benzaldehyde. The aldehyde group in 6 was reduced to an alcohol using LiAlH₄ to give 9, which was esterified with exo-5-norbornene-2-carboxylic acid to yield monomer 12. Monomer 11 was prepared in the same manner starting with compound 8.

Compound 4 was prepared in accordance with the procedure described in Beeby, A.; Bettington, S.; Samuel I. D. W.; Wang, Z. J. Mater. Chem. 2003, 13, 80, which is incorporated herein by reference in its entirety. Compounds 5 and 8 were prepared in accordance with the procedure described in Wang, X.-Y.; Kimyonok, A.; Weck, M. Chem. Commun. 2006, 3933, which is incorporated herein by reference in its entirety. Compounds 7 and 10 were prepared in accordance with the procedure described in Carlise, J. R.; Wang, X.-Y.; Weck, M. Macromolecules 2005, 38, 9000, which is incorporated herein by reference in its entirety.

Compound 13 was prepared in accordance with the procedure described in Cho, J.-Y.; Domercq, B.; Barlow, S.; Suponitsky, K. Y.; Li, J.; Timofeeva, T. V.; Jones, S.C.; Hayden, L. E.; Kimyonok, A.; South, C. R.; Weck, M.; Kippelen, B.; Marder, S. R., “Synthesis and Characterization of Polymerizable Phosphorescent Platinum(II) Complexes for Solution-Processible Organic Light-Emitting Diodes”, Organometallics, 2007, ASAP Web Release Date of Aug. 9, 2007.

Copolymerizations of 3, 10, 11, or 12 with 13 were carried out in chloroform at room temperature using Grubbs' third generation initiator. This initiator is described above (Scheme 2). All copolymerization were complete within 10 minutes. In all the copolymers synthesized in these experiments, a 9:1 ratio of 13 to the iridium complex containing monomer was employed and the target degree of polymerization was 50, i.e. monomer to catalyst ratios of 50:1 were employed. As mentioned, attempts to homopolymerize 3, and 10-12 resulted in precipitation of insoluble materials. The high solubilities of copolymers 14-17 in common organic solvents suggest a random distribution of the two monomers along the backbone.

### Example 1

Synthesis of 2,6-difluoro-3-pyridin-2-yl-benzoic acid (1). Under an argon atmosphere, 10.5 mL of a ⁿBuLi solution (1.6 M in hexanes, 16.8 mmol) was added dropwise at −78° C. to a tetrahydrofuran (THF) (55 mL) solution of 2-(2,4-difluoro-phenyl)pyridine (3.2 g, 16.8 mmol). The mixture was stirred for 20 minutes, followed by the addition of freshly crushed dry ice. After stirring for an additional 5 minutes, 10 mL of an aqueous HCl solution (1M) was added, followed by the addition of diethyl ether (30 mL). The organic layer was collected and the aqueous layer was washed three times with diethyl ether (30 mL). The combined organic layers were concentrated in vacuo, and the target compound was obtained by precipitation into hexanes (2.7 g, 68% yield). ¹H NMR (DMSO): δ=8.72 (d, 1H, J=3.3 Hz), 8.04 (d, 1H, J=6.9 Hz), 7.91 (m, 1H), 7.76 (m, 1H), 7.41 (m, 1H), 7.33 (t, 1H, J=8.7 Hz). ¹³C NMR (DMSO): δ=162.8, 161.5, 158.9, 158.0, 155.6, 151.8, 150.6, 137.8, 134.1, 124.9, 124.8, 123.9, 113.6, 113.4, 113.1. MS Calcd (M+1): 236.0. Found (ESI): 236.0 (M+1).

### Example 2

### Synthesis of 2,6-difluoro-3-pyridin-2-yl-benzoic acid bicyclo[2.2.1]hept-5-en-2-ylmethyl ester (2)

Compound 1 (2.7 g, 11.5 mmol), exo-5-norbornene-2-methanol (1.4 g, 11.5 mmol), and dimethylaminopyridine (0.3 g, 2.45 mmol) were combined in 100 mL of THF. A solution of dicyclohexylcarbodiimide (2.7 g, 13.1 mmol) in 10 mL of THF was added, and the reaction was stirred under argon at ambient temperatures for 24 hours. The solvent was evaporated and the residue was purified via column chromatography (silica, 4:1 hexanes:ethyl acetate) to give compound 2 as a clear oil (2.6 g, 66% yield). ¹H NMR (CDCl₃): δ=8.71 (d, 1H, J=4.8 Hz), 8.10 (m, 1H), 7.76 (t, 1H, J=1.5 Hz), 7.74 (m, 1H) 7.26 (m, 1H), 7.07 (td, 1H, J=8.7 Hz, 1.5 Hz), 6.09 (m, 2H), 4.45 (dd, 1H, J=6.6 Hz, 10.8 Hz), 4.28 (dd, 1H, J=9.3 Hz, 10.8 Hz), 2.85 (s, 1H), 2.80 (s, 1H), 1.86 (m, 1H), 1.37 (s, 2H), 1.30 (d, 1H, J=8.4 Hz), 1.24 (m, 1H). ¹³C NMR (CDCl₃): δ=162.5, 162.4, 159.9, 159.1, 158.9, 156.5, 151.9, 150.1, 137.2, 136.8, 136.4, 134.2, 134.1, 134.0, 124.6; 124.5, 123.0, 112.8, 112.7, 112.5, 112.4, 70.4, 45.2, 43.9, 41.9, 38.1, 29.8. MS Calcd (M): 341.2. Found (EI): 341.2 (M).

### Example 3

### Synthesis of fac-exo-bis(2-(4′,6′-difluorophenyl)-pyridinato, N, C²′)(2-(5′-bicyclo[2.2.1]hept-5-ene-2-yl ethanoyl-4′,6′-difluorophenyl)pyridinato, N, C²′) iridium(III) (3)

Compound 2 (75 mg, 0.22 mmol), (Ir(ppf)₂Cl)₂ (90 mg, 0.074 mmol), and AgCF₃SO₃ (38 mg, 0.148 mmol) were combined in 3 mL of ethoxyethanol. The mixture was purged with argon for 30 minutes followed by stirring at 150° C. for 24 hours under an argon atmosphere. The mixture was cooled to room temperature and water (10 mL) was added to precipitate the product. After filtration, the collected solid was purified via column chromatography (silica, CH₂Cl₂) to yield compound 3 (36 mg, 27% yield). ¹H NMR (CDCl₃): δ=8.33 (m, 3H), 7.72 (m, 3H), 7.45 (m, 3H), 6.96 (m, 3H), 6.41 (m, 3H), 6.25 (m, 2H), 6.09 (m, 2H), 4.39 (dd, 1H, J=6.6 Hz, 10.8 Hz), 4.19 (dd, 1H, J=9.3 Hz, 10.8 Hz), 2.84 (s, br, 2H), 1.85 (m, 1H), 1.37 (s, 2H), 1.28 (m, 2H). ¹³C NMR (CDCl₃): δ=163.7, 163.2, 160.1, 147.3, 147.1, 137.7, 132.6, 123.8, 123.5, 122.9, 122.5, 119.1, 118.2, 97.6, 68.9, 49.6, 44.2, 42.5, 37.9, 29.9, 29.2. MS Calcd (M): 912.9. Found (EI): 912.9 (M). Anal. Calcd. (C₄₂H₂₈F₆IrN₃O₂): C, 55.26; H, 3.09; N, 4.60. Found: C, 55.11; H, 3.22; N, 4.66.

### Example 4

### Synthesis of fac-bis(2-(benzo[b]thiophen-2-yl)-pyridinato, N, C³′)(2-(4′-formylphenyl)pyridinato, N, C²′) iridium(III) (6)

(Ir(btpy)₂Cl)₂ (1.0 g, 0.77 mmol), 4-(2-pyridyl)benzaldehyde (0.42 g, 2.3 mmol) and AgCF₃SO₃ (0.40 g, 1.5 mmol) were combined in 11 mL of ethoxyethanol. The reaction mixture was purged with argon for 30 minutes and then stirred at 150° C. for 24 hours under an argon atmosphere. The solution was cooled to room temperature and water (20 mL) was added to precipitate the product. After filtration, the collected solid was purified via column chromatography (silica, CH₂Cl₂) to yield compound 6 (0.18 g, 15% yield). ¹H NMR (CDCl₃): δ=9.62 (s, 1H), 7.78 (m, 4H), 7.51 (m, 7H), 7.39 (d, 1H, J=5.7 Hz), 7.33 (d, 1H, J=1.8 Hz), 7.24 (d, 1H, J=5.4 Hz) 7.09 (m, 2H), 6.93 (td, 1H, J=5.9 Hz, 1.5 Hz), 6.78 (t, 1H, J=7.6 Hz), 6.68 (m, 5H). ¹³C NMR (CDCl₃): δ=194.7, 165.6, 163.2, 162.6, 160.8, 156.6, 155.9, 150.7, 148.9, 148.1, 147.6, 146.9, 143.7, 143.3, 142.6, 137.6, 137.1, 136.2, 134.6, 134.4, 128.7, 125.2, 124.3, 123.8, 123.7, 122.5, 122.3, 119.9, 119.7, 118.9, 118.8. MS Calcd (M+1): 796.1. Found (ESI): 796.1 (M+1).

### Example 5

### Synthesis of fac-bis(2-(benzo[b]thiophen-2-yl)-pyridinato, N, C³′)(2-(4′-hydroxymethylphenyl)pyridinato, N, C²′) iridium(III) (9)

Compound 6 (50 mg, 0.062 mmol) was dissolved in 5 mL of THF and 0.08 mL of lithium aluminum hydride (1M in diethyl ether) was added dropwise. The reaction mixture was stirred at ambient temperatures for 45 minutes and then quenched by the addition of excess water. The crude product, which showed no remaining aldehyde signals by ¹H NMR spectroscopy, was dissolved in dichloromethane, washed three times with water, dried with MgSO₄ and used without further purification.

### Example 6

### Synthesis of fac-exo-bis(2-phenyl-quinolinato, N, C²′)(2-(4′-methyl bicyclo[2.2.1]hept-5-ene-2-carboxylphenyl)pyridinato, N, C²′) iridium(III) (11)

Compound 8 (1.220 g, 1.55 mmol), exo-5-norbornene-2-carboxylic acid (0.245 g, 1.77 mmol), and dimethylaminopyridine (0.100 g, 0.82 mmol) were combined in 60 mL of CH₂Cl₂. A solution of dicyclohexylcarbodiimide (0.370 g, 1.79 mmol) in 10 mL of CH₂Cl₂ was added and the reaction was stirred under argon at ambient temperatures for 24 hours. The solvent was evaporated and the residue was purified via column chromatography (silica, CH₂Cl₂) to give compound 11 as an orange powder (1.07 g, 76% yield). ¹H NMR (CDCl₃): δ=8.09 (m, 5H), 7.91 (d, 1H, J=8.4 Hz), 7.86 (d, 1H, J=6.9 Hz), 7.70 (m, 2H), 7.62 (d, 2H, J=9.0 Hz), 7.57 (d, 1H, J=9.0 Hz), 7.46 (td, 1H, J=9.0 Hz, 3.0 Hz), 7.40 (d, 1H, J=9.0 Hz), 7.22 (t, 1H, J=7.8 Hz), 7.16 (t, 1H, J=7.8 Hz), 6.95 (m, 3H), 6.71 (m, 7H), 6.50 (d, 1H, J=1.2 Hz), 6.14 (m, 2H), 4.82 (m, 2H), 2.97 (s, br, 1H), 2.91 (s, br, 1H), 2.20 (dd, 1H, J=7.2, 4.2), 1.88 (m, 1H), 1.44 (m, 1H), 1.33 (m, 2H). ¹³C NMR (CDCl₃): δ=176.2, 167.5, 167.4, 165.8, 163.2, 160.6, 158.4, 149.2, 148.8, 148.2, 146.4, 144.9, 143.7, 138.3, 137.6, 137.2, 137.1, 136.3, 136.1, 135.9, 133.3, 133.2, 130.4, 129.8, 129.7, 129.2, 128.4, 127.9, 127.8, 127.7, 127.1, 126.4, 126.3, 125.9, 125.3, 123.6, 122.3, 120.6, 120.2, 119.8, 119.2, 118.4, 118.1, 66.9, 46.8, 43.5, 41.9, 30.6, 30.5. MS Calcd (M): 905.3. Found (EI): 905.3 (M). Anal. Calcd. (C₅₀H₃₈IrN₃O₂): C, 66.35; H, 4.23; N, 4.64. Found: C, 66.21; H, 4.38; N, 4.67.

### Example 6′

Fac-exo-bis(2-phenyl-quinolinato, N, C2′)(2-(4′-(10-methoxy-10-oxodecyl bicyclo[2.2.1]hept-5-ene-2-carboxyl)phenyl)pyridinato, N, C2′) iridium(III) (11′). The norbornene acid (J. A. Love, J. P. Morgan, T. M. Trnka, R. H. Grubbs, Angew. Chem., Int. Ed. 2002, 41, 4035) (98 mg, 0.31 mmol) and 8 (200 mg, 0.25 mmol) and dimethylaminopyridine (17 mg, 0.14 mmol) were combined in 10 mL of CH₂Cl₂. A solution of dicyclohexylcarbodiimide (60 mg, 0.30 mmol) in 2 mL of CH₂Cl₂ was added and the reaction was stirred under argon at ambient temperatures for 24 h. The solvent was evaporated and the residue was purified via column chromatography (silica, CH₂Cl₂) to give compound 11′, as an orange powder (210 mg, 77% yield). ¹H NMR (CDCl₃): δ=8.19 (d, 111, J=9 Hz), 8.09 (m, 3H), 7.99 (d, 1H, J=9 Hz), 7.88 (m, 2H), 7.67 (m, 2H), 7.62 (m, 1H), 7.56 (d, 1H, J=8.7 Hz), 7.47 (m, 1H), 7.38 (d, 1H, J=8.1 Hz), 7.19 (m, 3H), 6.92 (m, 3H), 6.73 (m, 4H), 6.63 (m, 2H), 6.45 (d, 1H, J=1.8 Hz), 6.13 (m, 2H), 4.72 (s, 2H), 4.09 (t, 2H, J=6.9 Hz), 3.05 (s, 1H), 2.92 (s, 1H), 2.24 (t, 2H, J=7.5), 1.95 (m, 1H), 1.58 (m, 6H), 1.34 (m, 12H). ¹³C NMR (CDCl₃): δ=176.6, 173.9, 167.4, 165.8, 163.2, 160.6, 158.4, 149.2, 148.7, 148.2, 146.5, 144.9, 143.6, 138.3, 137.6, 137.1, 137.0, 136.3, 136.1, 135.9, 133.1, 130.4, 129.8, 129.6, 129.2, 128.4, 127.9, 127.8, 127.7, 127.1, 126.4, 126.3, 125.8, 125.3, 123.5, 122.3, 120.6, 120.2, 119.6, 119.1, 118.4, 118.2, 66.6, 64.9, 46.9, 46.6, 43.5, 41.9, 34.6, 30.6, 29.6, 29.5, 29.4, 29.3, 28.9, 26.2, 25.1. MS calculated: 1075.3, Found (ESI): 1008.3 (M-C₅H₇)

### Example 7

### Synthesis of fac-bis(2-benzo[b]thiophen-2-yl-pyridinato, N, C³′)(2-(4′-methyl bicyclo[2.2.1]hept-5-ene-2-carboxylphenyl)pyridinato, N, C²′) iridium(III) (12).

Compound 9 (143 mg, 0.18 mmol), exo-5-norbornene-2-carboxylic acid (29 mg, 0.21 mmol), and dimethylaminopyridine (10 mg, 0.08 mmol) were combined in 15 mL of CH₂Cl₂. A solution of dicyclohexylcarbodiimide (42 mg, 0.21 mmol) in 5 mL of CH₂Cl₂ was added, and the reaction was stirred under argon at ambient temperatures for 24 hours. The solvent was evaporated and the residue was purified via column chromatography (silica, CH₂Cl₂) to give compound 12 (81 mg, 49% yield). ¹H NMR (CDCl₃): δ=7.76 (d, 2H, J=8.1 Hz), 7.69 (d, 111, J=8.1 Hz), 7.62 (d, 111, J=8.4 Hz), 7.47 (m, 6H), 7.36 (d, 1H, J=6.0 Hz), 7.26 (d, 1H, J=5.1 Hz), 7.12 (td, 1H, J=7.2 Hz, 1.5 Hz), 7.05 (m, 1H), 6.93 (dd, 1H, J=6.3° Hz, 1.5 Hz), 6.85 (m, 3H), 6.67 (m, 5H), 6.06 (m, 2H), 4.87 (s, 2H), 2.83 (m, 2H), 2.01 (m, 1H), 1.55 (m, 1H), 1.34 (m, 1H), 1.23 (m, 2H). ¹³C NMR (CDCl₃): δ=176.2, 166.7, 163.4, 162.7, 161.8, 157.4, 155.3, 149.3, 147.8, 147.7, 147.5, 147.1, 144.6, 143.2, 142.6, 138.5, 138.0, 137.2, 136.9, 136.7, 136.2, 129.2, 128.8, 125.1, 124.9, 124.1, 123.7, 122.4, 122.3, 122.2, 120.4, 119.8, 118.8, 118.7, 66.7, 46.6, 43.3, 41.8, 30.4. MS Calcd (M) 917.2. Found (EI): 917.2 (M). Anal. Calcd. (C₄₆H₃₄IrN₃O₂S₂): C, 60.24; H, 3.74; N, 4.58. Found: C, 58.53; H, 3.62; N, 4.59.

General Polymerization Procedure

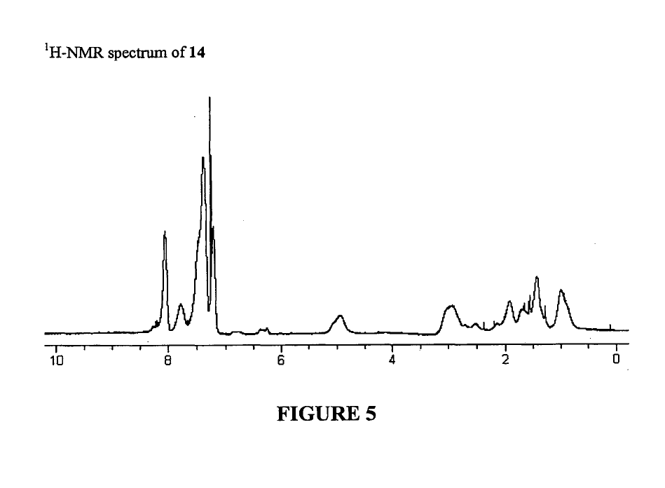

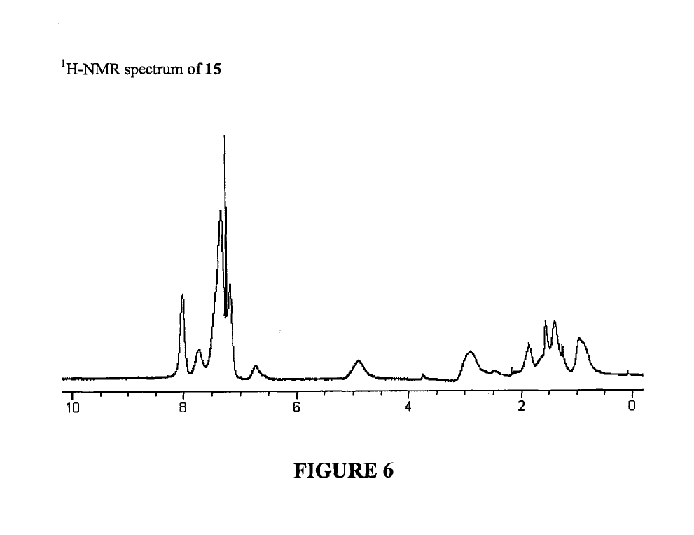

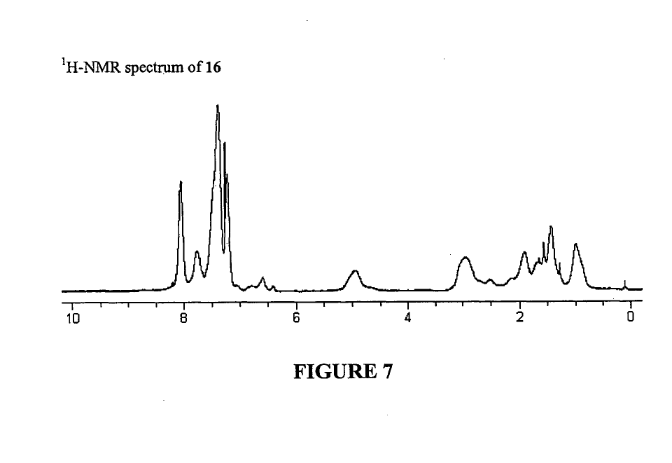

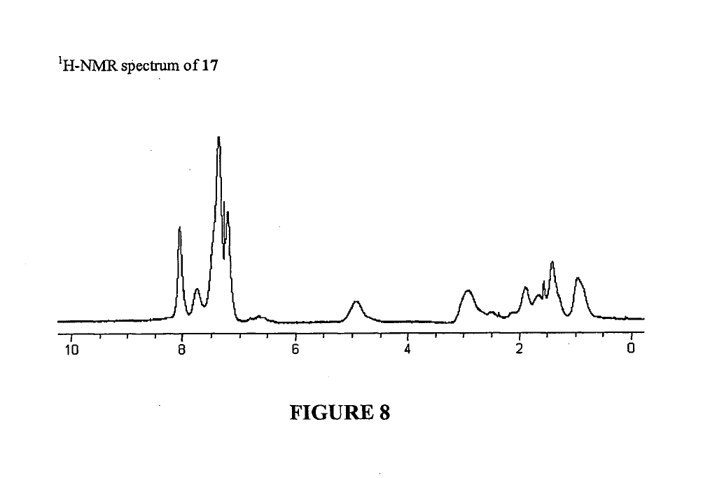

A solution of Grubbs' third generation initiator in chloroform (0.05 M) was added to a chloroform solution (0.01M) containing a mixture of 13 or 19 and the desired iridium-containing monomer (3, 10-12) in a ratio of 9:1, respectively. The reaction mixture was stirred for 20 minutes at ambient temperatures. After 20 minutes, the polymerization was quenched by the addition of ethyl vinyl ether. The reaction mixture was concentrated and precipitated into methanol. The resulting solid was collected by filtration, redissolved in CH₂Cl₂ and reprecipitated into methanol. This procedure was repeated until the methanol solution was clear to yield copolymers 14-17 for which ¹H-NMR spectra showed no remaining monomer or other impurity peaks. All copolymers were >97% pure by ¹H NMR (supplemental materials). The ¹H-NMR spectra is provided respectively at FIGS. 5-8. The copolymers were synthesized with a total monomer to catalyst ratio of 50:1.

General polymerization procedure for polymers in Table 3. A solution of Grubbs' third generation initiator^{[31]} in chloroform (0.05 M) was added to a chloroform solution (0.01 M) containing a mixture of monomers 13 or 19 and 11 or 11′ in the desired ratios (Table 1). The reaction mixture was stirred for 15 minutes at ambient temperatures. After 15 minutes, the polymerization was quenched by the addition of ethyl vinyl ether. The reaction mixture was concentrated and precipitated into methanol. The resulting solid was collected by filtration, redissolved in CH₂Cl₂ and reprecipitated into methanol. This procedure was repeated until the methanol solution was clear to yield copolymers 16-22′ for which ¹H-NMR spectra showed no remaining monomer or other impurity signals.

### Example 8

Copolymer 14. ¹H NMR (CDCl₃): δ=8.07 (br), 7.78 (br), 7.42 (br), 7.22 (br), 6.85 (br), 6.38 (br), 6.26 (br), 4.97 (br), 2.98 (br), 2.00 (br), 1.68 (br), 1.44 (br). ¹³C NMR (CDCl₃): δ=163.5, 163.0, 162.3, 154.0, 147.1, 141.1, 138.8, 137.6, 137.1, 134.1, 129.9, 126.3, 123.6, 121.8, 121.4, 120.6, 120.3, 118.2, 110.0, 97.4, 73.1, 71.0, 51.2, 42.7, 41.6, 37.1, 29.9, 26.8, 25.3. Anal. Calcd.: Ir, 2.75. Found: Ir, 2.16.

### Example 9

Copolymer 15. ¹H NMR (CDCl₃): δ=8.05 (br), 7.76 (br), 7.38 (br), 7.20 (br), 6.76 (br), 4.98 (br), 2.98 (br), 2.16 (br) 1.92 (br), 1.67 (br), 1.43 (br). ¹³C NMR (CDCl₃): δ=166.8, 166.3, 161.7, 161.2, 160.9, 154.1, 147.1, 143.7, 141.1, 138.7, 137.3, 137.0, 136.0, 134.6, 134.1, 133.1, 130.7, 130.1, 129.9, 127.9, 126.2, 124.1, 123.6, 121.8, 121.4, 120.6, 120.2, 118.9, 110.0, 73.0, 71.0, 51.2, 44.1, 42.3, 41.7, 38.9, 37.1, 29.9, 26.7, 25.4. Anal. Calcd.: Ir, 2.79. Found: Ir, 3.06.

### Example 10

Copolymer 16. ¹H NMR (CDCl₃): δ=8.07 (br), 7.8.1 (br), 7.42 (br), 7.21 (br), 6.82 (br), 6.63 (br), 4.98 (br), 3.05 (br), 1.98 (br), 1.68 (br), 1.42 (br). ¹³C NMR (CDCl₃): δ=167.4, 165.8, 160.4, 158.3, 154.0, 149.1, 148.4, 143.5, 141.1, 138.7, 137.0, 135.9, 133.3, 129.8, 128.3, 126.2, 125.2, 123.6, 121.8, 121.4, 120.6, 120.2, 119.3, 110.0, 72.9, 71.0, 51.2, 42.6, 41.5, 39.2, 37.1, 26.8, 25.4. Anal. Calcd.: Ir, 2.75. Found: Ir, 2.99.

### Example 11

Copolymer 17. ¹H NMR (CDCl₃): δ=8.06 (br), 7.77 (br), 7.40 (br), 7.21 (br), 6.82 (br), 6.65 (br), 4.97 (br), 2.98 (br), 1.92 (br), 1.68 (br), 1.43 (br). ¹³C NMR (CDCl₃): δ=167.5, 161.8, 157.8, 155.2, 154.0, 149.2, 147.8, 143.2, 142.6, 141.1, 138.7, 137.0, 134.1, 129.9, 126.2, 125.1, 123.6, 121.8, 121.4, 120.6, 120.2, 118.6, 110.0, 73.0, 71.0, 51.2, 46.0, 42.7, 39.2, 37.1, 26.8, 25.3. Anal. Calcd.: Ir, 2.75. Found: Ir, 2.77.

### Example 12

### Synthesis of 9-[3-(Bicyclo[2.2.1]hept-5-en-2-ylester)-propyl]-2,7-bis-carbazol-9-yl-9-methyl-9H-fluorene (19)

A mixture of 4-(dimethylamino)-pyridine (DMAP) (0.078 g, 0.64 mmol), 3-(2,7-di(9H-carbazol-9-yl)-9-methyl-9H-fluoren-9-yl)propan-1-ol (4.01 g, 7.03 mmol), and endo/exo norbornene carboxylic acid (0.883 g, 6.39 mmol) in 16 mL dry THF was allowed to cool to 0° C. Dicyclohexylcarbodiimide (DCC) (1.46 g, 7.03 mmol) was added and the mixture was stirred at room temperature overnight. The urea precipitate was filtered from the reaction mixture and the filtrate was poured into a mixture of H₂O and diethyl ether. The aqueous layer was extracted with diethyl ether. The combined organic layers were washed with saturated sodium bicarbonate, brine solution, and dried over MgSO₄. The solvent was removed under reduced pressure to yield a white crystalline solid mixed in a yellow oil. The product was purified using column chromatography (silica gel, hexanes:ethylacetate=10:1) to give a white solid (2.81 g, 63.8%). Endo and exo isomers. ¹H NMR (400 MHz, CDCl₃, 8): 8.17 (d, J=7.7 Hz, 4H), 7.99 (d, J=7.8 Hz, 2H), 7.60 (m, 4H), 7.41-7.48 (m, 8H), 7.28-7.33 (m, 4H), 6.00 (dd, J=5.6 Hz, 3.1 Hz, 1H), 5.76 (dd, J=5.6 Hz, 2.8 Hz, 1H), 2.76-3.02 (m, 2H), 2.71 (br, 1H), 2.03-2.15 (m, 2H), 1.69 (ddd, J=11.4 Hz, 9.2 Hz, 3.8 Hz, 1H), 1.62 (s, 3H), 1.19-1.41 (m, 6H), 0.82-1.07 (m, 3H). ¹³C{¹H} NMR (400 Mz, CDCl₃, δ): 176.17, 153.52, 140.91, 138.58, 137.06, 132.31, 126.22, 125.90, 123.44, 122.08, 121.35, 120.16, 120.04, 110.91, 109.91, 109.55, 63.99, 50.98, 49.45, 45.70, 43.19, 36.98, 31.92, 29.12, 26.70, 24.22.

### Example 13

Copolymer 22. ¹H NMR (CDCl₃): δ=8.07 (br), 7.81 (br), 7.40 (br), 7.23 (br), 6.79 (br), 6.63 (br), 5.02 (br), 4.71 (br), 3.78 (br), 2.56 (br), 1.90 (br), 1.49 (br), 1.12 (br). ¹³C NMR (CDCl₃): δ=167.0, 165.2, 160.3, 158.1, 153.3, 148.7, 145.9, 144.5, 143.0, 140.6, 138.1, 137.2, 136.7, 130.0, 129.3, 128.1, 127.5, 125.9, 125.3, 123.2, 121.5, 121.2, 120.4, 119.8, 117.7, 109.8, 66.4, 63.8, 50.9, 41.7, 36.7, 26.6, 24.4.

### Example 14

Copolymer 22′. ¹H NMR (CDCl₃): δ=8.06 (br), 7.84 (br), 7.48 (br), 7.21 (br), 6.89 (br), 6.68 (br), 4.99 (br), 4.74 (br), 3.72 (br), 2.64 (br), 1.95 (br), 1.50 (br), 1.09 (br). ¹³C NMR (CDCl₃): δ=167.5, 165.6, 163.1, 160.5, 158.5, 153.7, 149.2, 148.8, 148.2, 146.5, 144.9, 143.6, 141.1, 138.8, 137.6, 137.2, 136.3, 133.1, 132.4, 130.5, 129.8, 128.4, 127.9, 126.5, 123.7, 121.9, 121.6, 120.7, 120.4, 119.7, 119.1, 118.2, 110.0, 66.8, 64.3, 60.7, 51.2, 49.7, 46.2, 45.8, 43.6, 42.5, 37.0, 34.9, 32.1, 29.7, 26.9, 25.5, 24.4, 22.9.

### Example 15

### Device Fabrication with Copolymer 15

For the hole-transport layer, 10 mg of Poly-TPD-OMe 18 were dissolved in 1 ml of distilled and degassed toluene. For the emissive layer, 20 mg of Copolymer 15 were dissolved in 3 ml of distilled and degassed chloroform. Both solutions were made under inert atmosphere and were stirred overnight.

35 nm thick films of the hole-transport material were spin coated (60 s@1500 rpm, acceleration 10,000) onto air plasma treated indium tin oxide (ITO) coated glass substrates with a sheet resistance of 20Ω/□ (Colorado Concept Coatings, L.L.C.). Films were crosslinked using a standard broad-band UV light with a 0.7 mW/cm² power density for 1 minute. Subsequently, a 30 nm thick film of the Copolymer 15 solution was spin coated on top of the crosslinked hole-transport layer (60 s@1500 rpm, acceleration 10,000). For the hole-blocking layer, a 6 nm-thick film of bathocuproine (2,9-dimethyl-4,7-diphenyl-1,10-phenanthroline, BCP) was thermally evaporated at a rate of 0.4 Å/s on top of the emissive layer. A 20 nm-thick film of tris-(8-hydroxyquinolinato-N,O) aluminum (Alq₃) was then thermally evaporated as electron-transport layer at a rate of 1 Å/s on top of the hole-blocking layer. All evaporated small molecules had previously been purified using gradient zone sublimation. Organic materials were thermally evaporated at a pressure below 1×10⁻⁷ Torr.

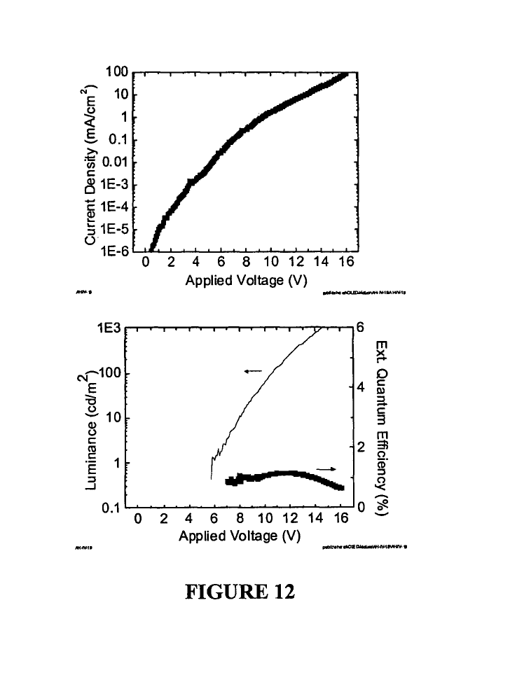

Finally, 1 nm of lithium fluoride (LiF) as an electron-injection layer and a 200 nm-thick aluminum cathode were vacuum, deposited at a pressure below 1×10⁻⁶ Torr and at rates of 0.1 Å/s and 2 Å/s, respectively. A shadow mask was used for the evaporation of the metal to form five devices with an area of 0.1 cm² per substrate. At no point during fabrication, the devices were exposed to atmospheric conditions. The testing was done right after the deposition of the metal cathode in inert atmosphere without exposing the devices to air. The device performance is shown in FIG. 12

### Example 16

### Device Fabrication with Copolymer 21′

For the hole-transport layer, 10 mg of Poly-TPD-F 24 were dissolved in 1 ml of distilled and degassed toluene. For the emissive layer, 5 mg of Copolymer 21′ were dissolved in 1 ml of distilled and degassed chloroform. Both solutions were made under inert atmosphere and were stirred overnight.

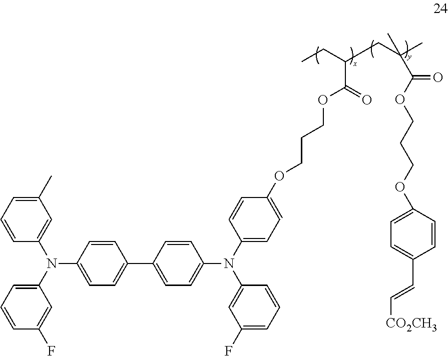

35 nm thick films of the hole-transport material were spin coated (60 s@1500 rpm, acceleration 10,000) onto air plasma treated indium tin oxide (ITO) coated glass substrates with a sheet resistance of 20Ω/□ (Colorado Concept Coatings, L.L.C.). Films were crosslinked using a standard broad-band UV light with a 0.7 mW/cm² power density for 1 minute. Subsequently, a 20 nm thick film of the Copolymer 21′ solution was spin coated on top of the crosslinked hole-transport layer (60 s@1500 rpm, acceleration 10,000). For the hole-blocking layer, bathocuproine (2,9-dimethyl-4,7-diphenyl-1,10-phenanthroline, BCP) was first purified using gradient zone sublimation, and a film of 40 nm was then thermally evaporated at a rate of 0.4 Å/s and at a pressure below 1×10⁻⁷ Torr on top of the emissive layer.

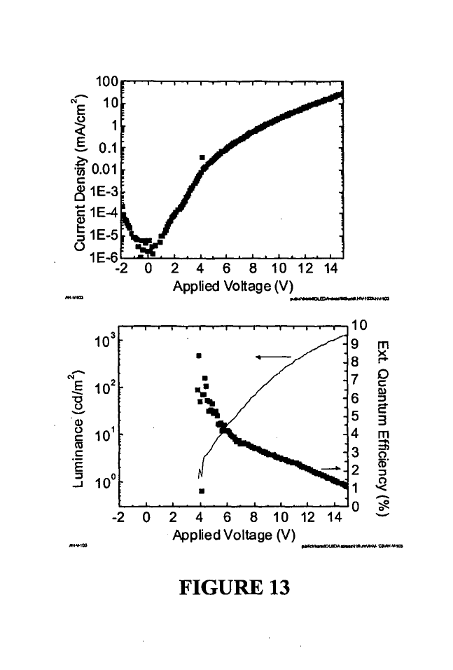

Finally, 1 nm of lithium fluoride (LiF) as an electron-injection layer and a 200 nm-thick aluminum cathode were vacuum deposited at a pressure below 1×10⁻⁶ Torr and at rates of 0.1 Å/s and 2 Å/s, respectively. A shadow mask was used for the evaporation of the metal to form five devices with an area of 0.1 cm² per substrate. At no point during fabrication, the devices were exposed to atmospheric conditions. The testing was done right after the deposition of the metal cathode in inert atmosphere without exposing the devices to air. The device performance is shown in FIG. 13.

### Example 17

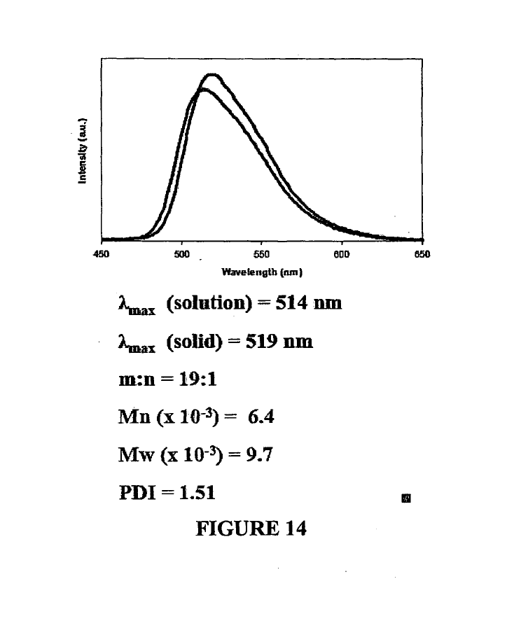

Some physical data for an example of Copolymer 21′ is shown in FIG. 14.

### Example 18

Physical data for an example of Copolymer 31′ is shown in FIG. 15.

TABLE 1
Polymer characterization data.

| | M_{w} | Mₙ | | T_{d} |
|---|---|---|---|---|
| Compound | (×10⁻³) | (×10⁻³) | PDI | (° C.)^{a} |
| 14 | 23.5 | 18.5 | 1.24 | 318 |
| 15 | 25.5 | 19.5 | 1.31 | 324 |
| 16 | 24.5 | 19.0 | 1.29 | 302 |
| 17 | 23.0 | 19.0 | 1.22 | 303 |

^{a}Temperature at 5% weight loss.

TABLE 2
Photophysical and electroluminescence characterization of copolymers 14-17.

| Compound | λ_{abs} (nm)^{a} | λₑₘ (nm)^{a,f} | λₑₘ (nm)^{b,f} | Φ^{c} | τ (μs)^{d} | τ (μs)^{e} | λₑₗ (nm)^{g} |
|---|---|---|---|---|---|---|---|
| 14 | 296, 343, 379 | 468 | 474 | 0.41 | 0.0637 | 1.30 | 511 |
| 15 | 295, 343, 382 | 512 | 517 | 0.33 | 0.0848 | 1.43 | 521 |
| 16 | 295, 342, 408 | 591 | 595 | 0.10 | 0.1936 | 1.34 | 603 |
| 17 | 297, 339, 408 | 600 | 600 | 0.07 | 0.1664 | 3.71 | 602 |

^{a}In chloroform solutions.
^{b}Peak emission in solid state.
^{c}In degassed solutions using fac-Ir(ppy)₃ (Φ = 0.40, in toluene).
^{d}Luminescence lifetimes in THF solution.
^{e}Luminescence lifetimes in degassed THF solution.
^{f}All polymers were excited at 400 nm.
^{g}Peak EL emission.

Table 3: Characterization of copolymers with peak maxima of solid-state photoluminescence and electroluminescence spectra, plus external quantum efficiency and luminous efficiency at 100 cd/m² for devices based on phosphorescent copolymers with different molecular weight, different iridium concentration, and different linkages between the side groups and the polymer backbone. The device structure was ITO/24 (35 nm)/16,22,22′(a-c)(2-40) (20-25 nm)/BCP (40 nm)/LiF (1 nm)/Al. For the nomenclature in the “Polymer” column, the first numeric index (16,22,22′) is used to identify the polymers described above. The second index (a-c) refers to the molecular weight range of the copolymer, and finally the third index (n) refers to the percentage of iridium containing monomer relative to the total number monomers used in the polymerization.

| | m:n | Mₙ | | λ_{max, PL} | λ_{max, EL} | | Luminous |
|---|---|---|---|---|---|---|---|
| Polymer | (mol %) | (×10³ g/mol) | PDI | (nm) | (nm) | EQE (%) | efficiency (cd/A) |
| 16a(10) | 89:11 | 19.0 | 1.29 | 594 | 600 | 2.9 ± 0.3 | 3.9 ± 0.4 |
| 16b(10) | 92:8 | 70.0 | 1.33 | 590 | 602 | 3.2 ± 0.3 | 4.9 ± 0.4 |
| 16c(10) | 90:10 | 238.0 | 1.47 | 591 | 607 | 1.5 ± 0.1 | 2.0 ± 0.1 |
| 16a(2) | 98:2 | 16.0 | 1.34 | 595 | 596 | 1.9 ± 0.3 | 2.6 ± 0.4 |
| 16a(5) | 95:5 | 23.0 | 1.26 | 605 | 598 | 3.4 ± 0.4 | 4.6 ± 0.5 |
| 16a(7) | 93:7 | 16.0 | 1.43 | 597 | 602 | 3.0 ± 0.4 | 4.1 ± 0.5 |
| 16a(15) | 81:19 | 21.0 | 1.48 | 605 | 607 | 2.4 ± 0.2 | 3.2 ± 0.3 |
| 16a(20) | 79:21 | 19.5 | 1.44 | 604 | 607 | 2.0 ± 0.1 | 2.7 ± 0.2 |
| 16a(30) | 75:25 | 19.5 | 1.32 | 612 | 611 | 1.9 ± 0.1 | 2.6 ± 0.1 |
| 16a(40) | 71:29 | 27.0 | 1.25 | 613 | 612 | 1.7 ± 0.1 | 2.3 ± 0.1 |
| 22a(10) | 90:10 | 16.0 | 1.31 | 592 | 605 | 3.9 ± 0.3 | 5.3 ± 0.4 |
| 22′a(10) | 90:10 | 20.0 | 1.21 | 594 | 603 | 4.5 ± 0.5 | 8.0 ± 0.9 |
| 22′a(5) | 95:5 | 16.5 | 1.21 | 595 | 597 | 4.9 ± 0.4 | 8.8 ± 0.7 |

FIG. 9 shows the external quantum efficiency as a function of the loading level of the iridium complex in the copolymer for OLEDs with device configuration ITO/24 (35 nm)/16a(2-40) (20-25 nm)/BCP (40 nm)/LiF (1 nm)/Al.

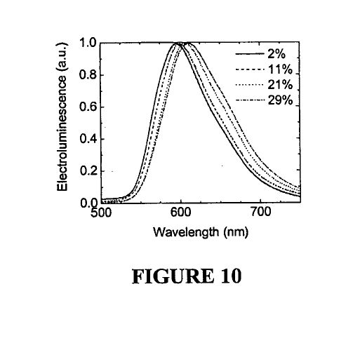

FIG. 10 shows the electroluminescence spectra for OLED devices using 16a(2, 10, 20, 40) copolymers with increasing iridium complex content as emitting layer.

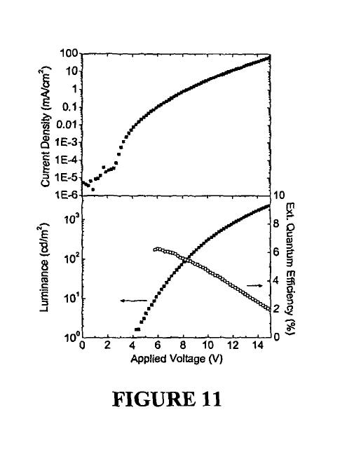

FIG. 11 shows the current density (solid symbols, top), luminance (solid symbols, bottom), and external quantum efficiency (empty symbols, bottom) as a function of applied voltage for a device with structure ITO/24 (35 nm)/22′ a(5) (25 nm)/BCP (40 nm)/LiF (1 nm)/Al.

1-46. (canceled)

47. A polymer having the formula: 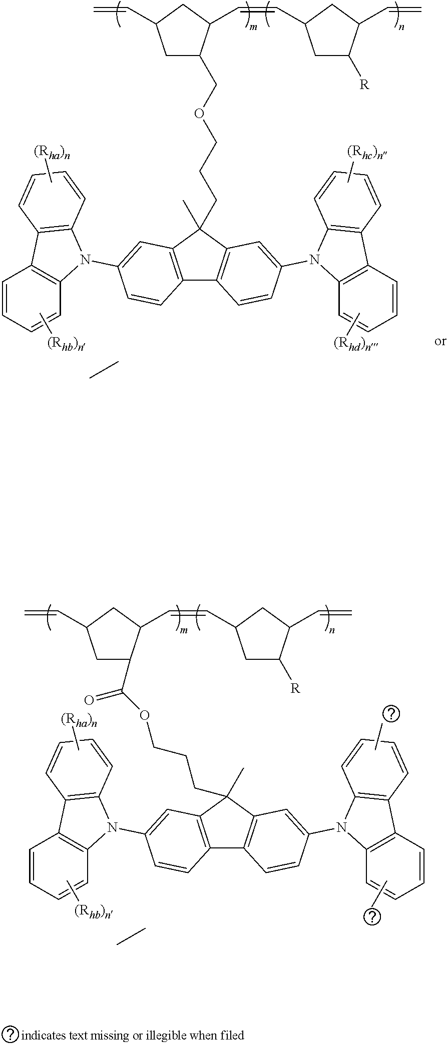
wherein each Rₕₐ, R_{hb}, R_{hc}, or R_{hd}, group is independently selected from hydroxy, sulfhydril, F, Cl, Br, I, nitro, —NH₂, —SO₃H, —SO₃⁻ salts, —PO₃H₂, —PO₃H⁻ salts, —PO₃⁼ salts; or C₁-C₈ organic substituent groups independently selected from alkyl, alkoxy, hydroxyalkyl, alkoxyalkyl, —C(O)—Rₜ where Rₜ is alkyl or alkoxy, —O₂C—Rₜ where Rₜ is alkyl or alkoxy, —CO₂H or —CO₂⁻ salts, phenyl or substituted phenyl, furanyl or substituted furanyl, thiofuranyl or substituted thiofuranyl, —CN, perfluoroalkyl, perfluoroalkoxy, NHRₜ where Rₜ is alkyl or alkoxy, N(Rₜ)₂ where Rₜ is alkyl or alkoxy, —N═N—Rₜ where Rₜ is alkyl, alkoxy, or phenyl or substituted phenyl, —S—Rₜ where Rₜ is alkyl alkoxy or phenyl or substituted phenyl, or P(Rt)₃ wherein Rₜ is alkyl alkoxy or phenyl or substituted phenyl;
and wherein n, n′, n″, and n′″, are integer indexes that can be the same or different and have the values 0, 1, 2, or 3, and
wherein R is 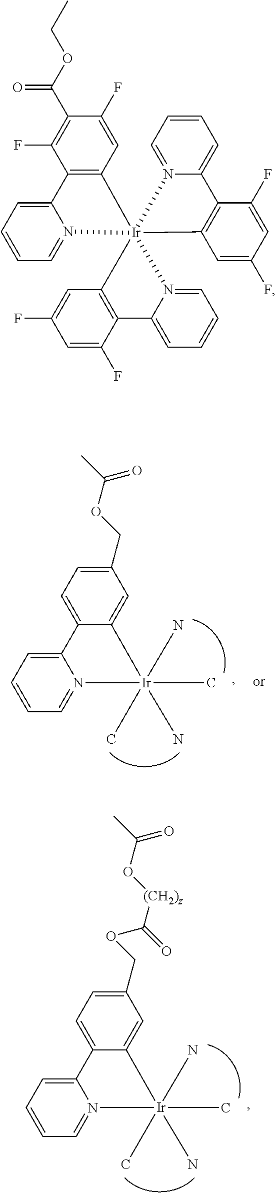
wherein 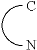
is 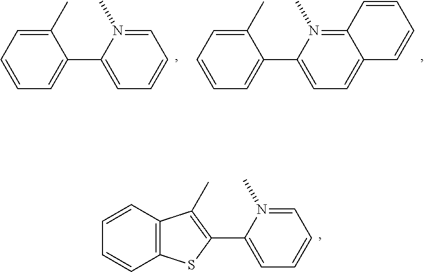
or 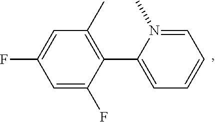
wherein the 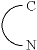
ligand is the same in each instance for the respective compound, z is an integer from 1 to 10, and
n is an integer from 5 to 30, and m:n is from 70:30 to 95:5.

48. A light emitting diode comprising at least one of the polymers of claim 47.

49. A polymer having the formula: 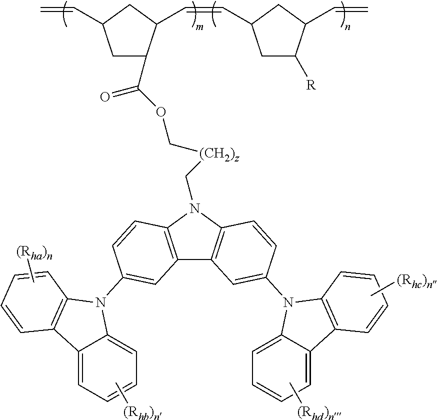
wherein each Rₕₐ, R_{hb}, R_{hc}, or R_{hd}, group is independently selected from hydroxy, sulfhydril, F, Cl, Br, I, nitro, —NH₂, —SO₃H, —SO₃⁻ salts, —PO₃H₂, —PO₃H⁻ salts, —PO₃⁼ salts; or C₁-C₈ organic substituent groups independently selected from alkyl, alkoxy, hydroxyalkyl, alkoxyalkyl, —C(O)—Rₜ where Rₜ is alkyl or alkoxy, —O₂C—Rₜ where Rₜ is alkyl or alkoxy, —CO₂H or —CO₂⁻ salts, phenyl or substituted phenyl, furanyl or substituted furanyl, thiofuranyl or substituted thiofuranyl, —CN, perfluoroalkyl, perfluoroalkoxy, NHRₜ where Rₜ is alkyl or alkoxy, N(Rₜ)₂ where Rₜ is alkyl or alkoxy, —N═N—Rₜ where Rₜ is alkyl, alkoxy, or phenyl or substituted phenyl, —S—Rₜ where Rₜ is alkyl alkoxy or phenyl or substituted phenyl, or P(Rt)₃ wherein Rₜ is alkyl alkoxy or phenyl or substituted phenyl;
and wherein n, n′, n″, and n′″, are integer indexes that can be the same or different and have the values 0, 1, 2, or 3, and
n is an integer from 5 to 30; m:n is from 70:30 to 95:5,
R is 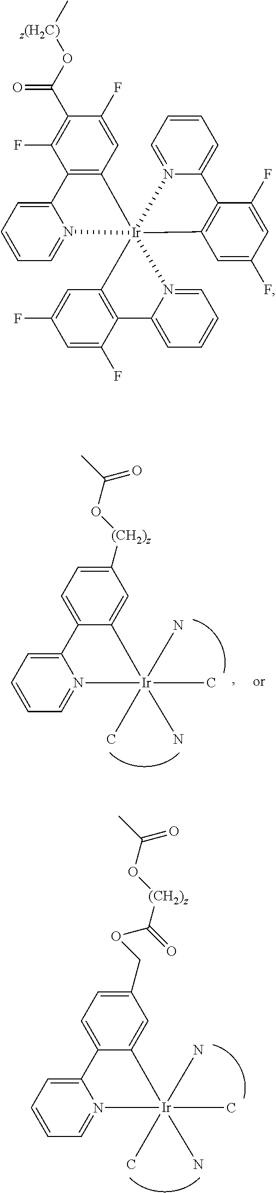
wherein
z is an integer from 1 to 10; 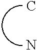
is 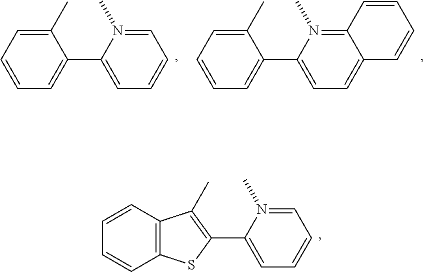
or 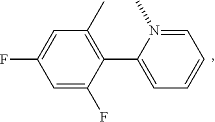
wherein the 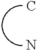
ligand is the same in each instance for the respective compound.

50. A light emitting diode comprising at least one of the polymers of claim 49.

51-52. (canceled)

53. A random or block copolymer having the structure: 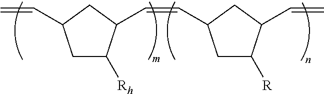
wherein Rₕ is a host group comprising at least one poly-unsaturated and polycyclic heteroaromatic groups capable of conducting both holes and electrons, and R is a group linked to a phosphorescent metal complex, n is an integer from 5 to 30; and the ratio m:n is from 70:30 to 95:5,
wherein R has the structure 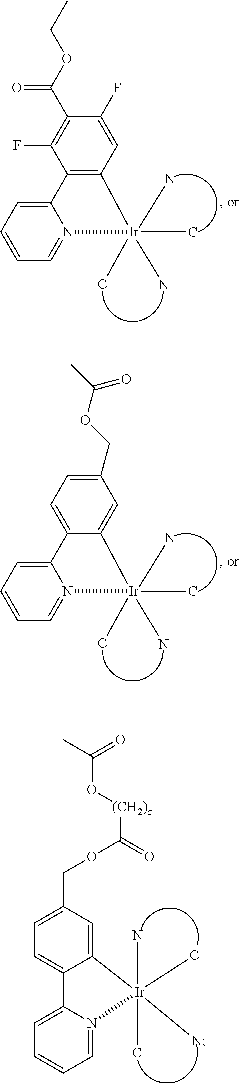
and z is an integer from 1 to 20, or 1 to 10, and
wherein both the bidentate 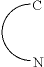
ligands have a structure selected from the group consisting of 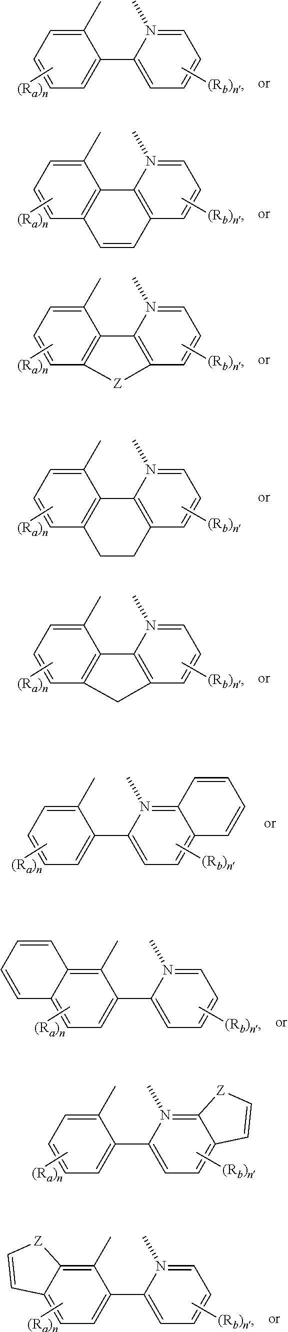 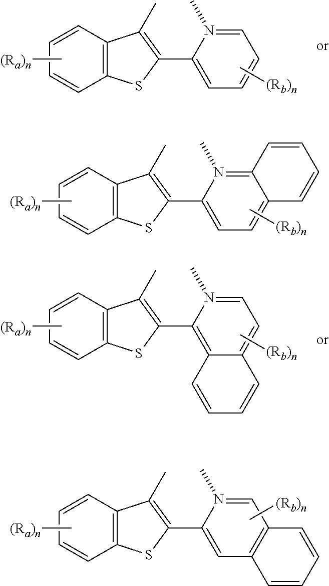
wherein Z is O or S, and
wherein each Rₐ and R_{b} group is independently selected from hydroxy, sulfhydril, F, Cl, Br, I, nitro, —NH₂, —SO₃H, —SO₃⁻ salts, —PO₃H₂, —PO₃H⁻ salts, —PO₃⁼ salts; or C₁-C₈ organic substituent groups independently selected from alkyl, alkoxy, hydroxyalkyl, alkoxyalkyl, —C(O)—Rₜ where Rₜ is alkyl or alkoxy, —O₂C—Rₜ where Rₜ is alkyl or alkoxy, —CO₂H or —CO₂⁻ salts, phenyl or substituted phenyl, furanyl or substituted furanyl, thiofuranyl or substituted thiofuranyl, —CN, perfluoroalkyl, perfluoroalkoxy, NHRₜ where R_{E} is alkyl or alkoxy, N(Rₜ)₂ where Rₜ is alkyl or alkoxy, —N═N—Rₜ where Rₜ is alkyl, alkoxy, or phenyl or substituted phenyl, —S—Rₜ where Rₜ is alkyl alkoxy or phenyl or substituted phenyl, or P(Rt)₃ wherein Rₜ is alkyl alkoxy or phenyl or substituted phenyl;
and wherein n and n′ are integer indexes that are the same or different and have the values 0, 1, 2, or 3.

54. The copolymer of claim 53 wherein Rₕ has one of the structures: 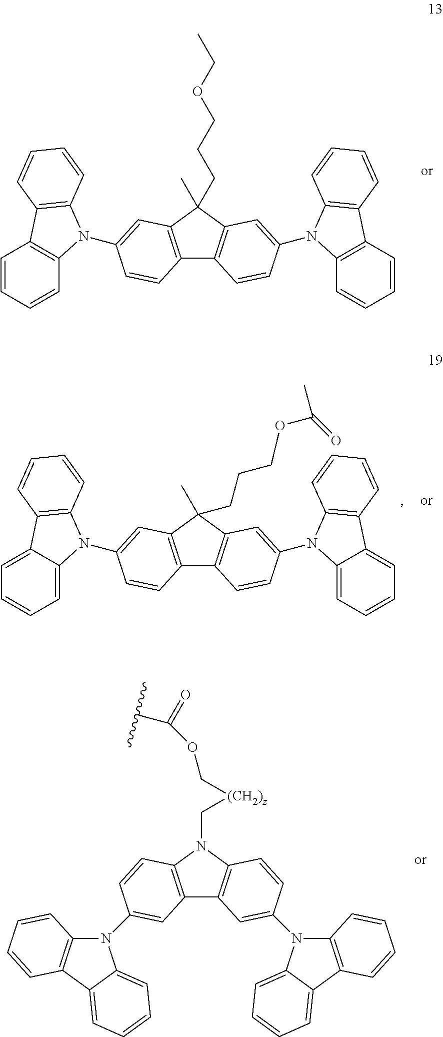 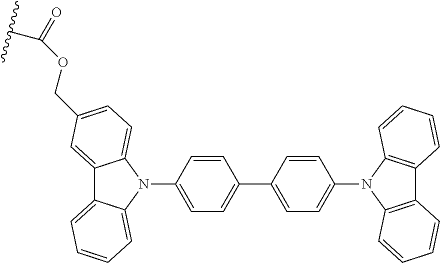
wherein z is an integer from 1 to 20.

55. An organic light emitting diode comprising the copolymer of claim 53 or a crosslinked derivative thereof.

56. (canceled)

57. The polymer of claim 53, wherein R is:

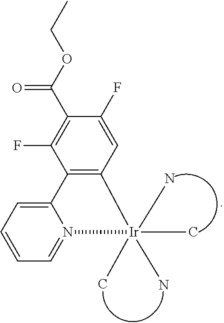

58. The polymer of claim 53, wherein R is:

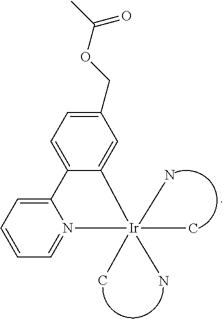

59. The polymer of claim 53, wherein R is:

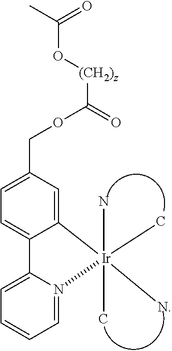

60. The polymer of claim 53, wherein R is:

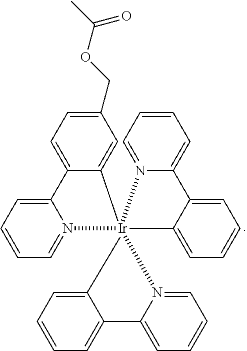

61. The polymer of claim 53, wherein R is:

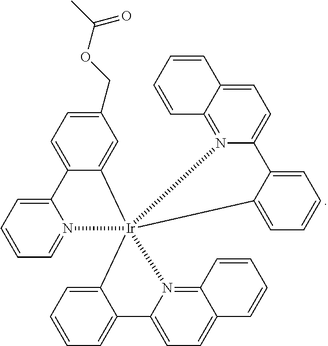

62. The polymer of claim 53, wherein R is:

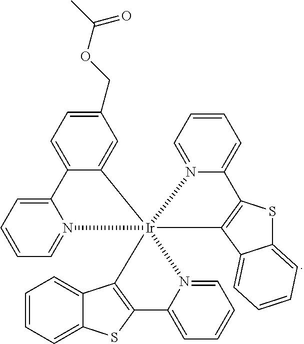

63. The copolymer of claim 53, wherein at least one of n or n′ is not zero.

64. The copolymer of claim 53, wherein Rₕ has one of the structures: 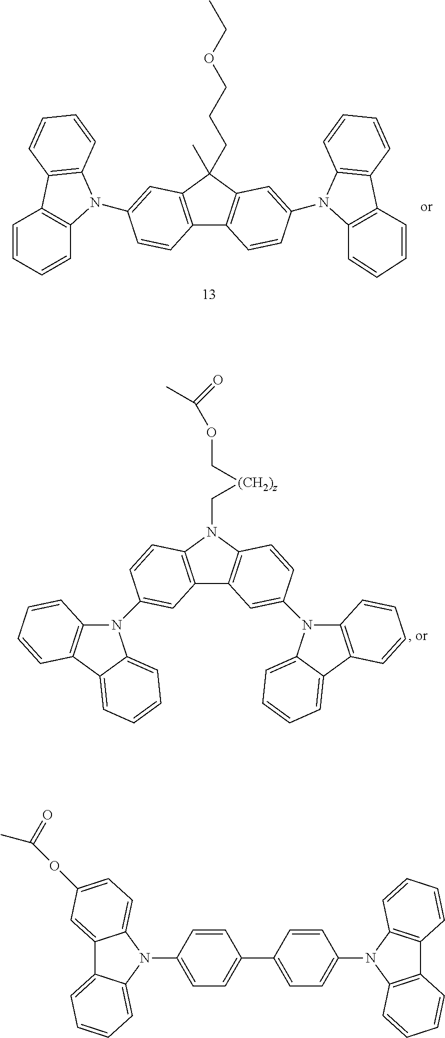
wherein z is an integer from 1 to 20.

65. The polymer of claim 47, having the structure

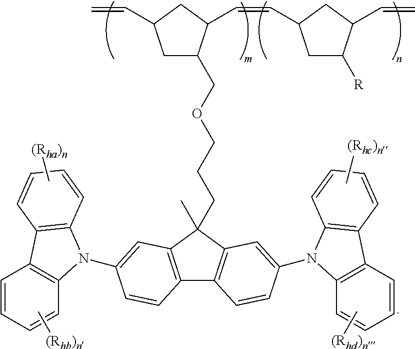

66. The polymer of claim 47, having the structure

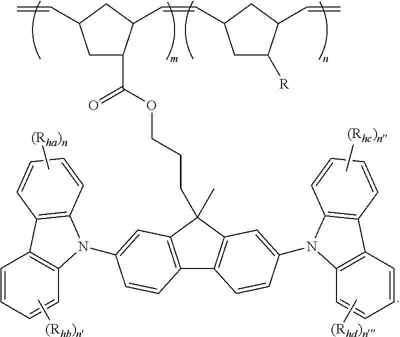

67. The polymer of claim 47, having the structure

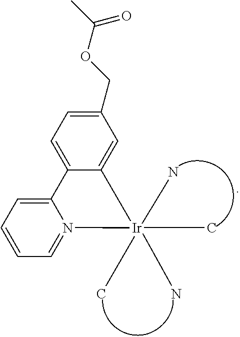

68. The polymer of claim 47, having the structure

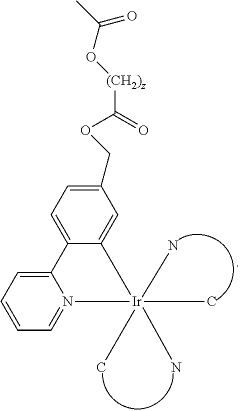

69. The polymer of claim 47, having the structure [chemical structure]
